(19) United States
(12) Patent Application Publication
(10) Pub. No.: US 2017/0142226 A1
(43) Pub. Date: May 18, 2017

(54) METHODS, APPARATUSES AND SYSTEMS DIRECTED TO ENABLING NETWORK FEDERATIONS THROUGH HASH-ROUTING AND/OR SUMMARY-ROUTING BASED PEERING

(71) Applicant: InterDigital Patent Holdings, Inc., Wilmington, DE (US)

(72) Inventors: Xavier De Foy, Montreal (CA); Hang Liu, North Potomac, MD (US); Alexander Reznik, Pennington, NJ (US); Bartosz Balazinski, Montreal (CA); Juan Carlos Zuniga, Montreal (CA)

(21) Appl. No.: 15/115,113

(22) PCT Filed: Jan. 31, 2015
(86) PCT No.: PCT/US15/14016

§ 371 Date: Jul. 28, 2016

Related U.S. Application Data
(60) Provisional application No. 61/934,540, filed on Jan. 31, 2014.

(51) Int. Cl. H04L 29/08; H04L 12/733; H04L 12/743

(52) U.S. Cl. CPC H04L 67/327; H04L 45/7453; H04L 45/122; H04L 67/2842; H04L 67/104

(57) ABSTRACT

Methods, apparatus, systems, devices, and computer program products directed to enabling federation 200 of multiple independent networks 204A, 204B, 204C, 204D through hash-routing based peering (HRP) and/or summary-routing based peering (SRP) are provided. Pursuant to new methodologies and/or technologies provided herein the multiple independent networks self-organize, or otherwise assemble, as a federation of network peers. The network peers 204A, 204B, 204C, 204D cooperate to pool and/or merge resources to make available for the federation 200 a population of content objects. As members of the federation, each of the network peers undertakes responsibility for making available to other network peers a share of the population. The multiple independent networks establish connectivity and federate using an HRP protocol. Pursuant to the HRP protocol, the network peers allocate amongst themselves respective key ranges within a hash-value space of a hash function. The network peers employ an allocation strategy to guide allocation of the hash-value space. When one of the network peers 204C receives a content request 201 from a local end user 202, local router or another network, the network peer routes and/or forwards the content request over a backhaul or transit network 216C or any link not part of the peering network if the content request falls into the content-object population allocated to this peer. Alternatively, the network peer routes and/or forwards the content request 201 through another network peer for processing if a hash value calculated from the content request falls within a key range of a hash value space allocated to such network peer. Logically merging the multiple individual networks as a federation with the logically combined backhaul and/or caching resources of the network peers 204A, 204B, 204C, 204D, should result in an efficiency gain because of a higher cache-hit ratio, since the merged caching resources supports a larger population. Federating the multiple individual networks using the HRP protocol enables such logical merging of caching storage capacity and transit (or backhaul) transfer capacity of the multiple individual networks.

### BACKGROUND

Information centric networking (ICN) is a recent networking paradigm. Under ICN, a content object is the primary object in communication. Multiple system designs have been proposed to implement ICN, including content centric networking (CCN), network of information (NetInf) and publish-subscribe internet routing paradigm (PSIRP). In some solutions, a request for a content object (“content request”) message is routed using a name of the content object (“content name”) itself. The system designs that use such “route-by-name” solutions include, for example, CCN and a variant of NetInf. In other solutions, a two-step approach is used. First, the content name is used in a lookup to obtain a locator. And second, the locator is then used to obtain the content object. The system designs that use such two-step “lookup-by-name” approaches include PSIRP and a variant of NetInf.

What is needed is a way to carryout ICN inter-domain networking, aiming to optimize both caching and transit costs for all peers.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIGS. 1C, 1D, and 1E are system diagrams of example radio access networks and example core networks that may be used within the communications system illustrated in FIG. 1A;

FIG. 2 is a block diagram illustrating an example network federation in which one or more disclosed embodiments may be implemented;

FIG. 3 is a block diagram illustrating an example network federation in which one or more disclosed embodiments may be implemented;

FIG. 4 is a block diagram illustrating an example federation based on hash-routing based peering (HRP) and illustrating HRP routing tables of network peers of the federation;

FIG. 5 is a block diagram illustrating example HRP routing tables of the network peers of the federation illustrated in FIG. 4;

FIG. 6 is a block diagram illustrating example HRP routing tables of the network peers of the federation illustrated in FIG. 4;

FIG. 7 is a block diagram illustrating example HRP routing tables of the network peers of the federation illustrated in FIG. 4;

FIG. 8 is a block diagram example HRP routing tables of the network peers of the federation illustrated in FIG. 4;

FIG. 9 is a graph illustrating example empirical link usage with and without HRP;

FIG. 10 is a message flow diagram illustrating an example HRP routing message flow;

FIG. 11 is a flow diagram illustrating an example flow for making forwarding decisions in a HRP router;

FIG. 12 is a block diagram illustrating example software-defined networking (SDN) stack and connectivity for centralized exterior HRP;

FIG. 13 is a block diagram illustrating example SDN stack and connectivity for centralized interior HRP;

FIG. 14 is a block diagram illustrating an example message structure for open shortest path first (OSPF) Opaque LSA extension for HRP key range allocation advertisements;

FIG. 15 illustrates an example Content Centric Networking (CCN) Forwarding Information Base (FIB) enhanced to support HRP routing;

FIG. 16 is a flow diagram illustrating an example forwarding decision flow that may be carried out by a HRP-enhanced interior CCN router;

FIG. 17 illustrates a forwarding decision procedure in a HRP-enhanced interior CCN router;

FIG. 18 illustrates a Border Gateway Patrol (BGP) Network Layer Reachability Information (NLRI) format for HRP Reachability Information;

FIG. 19 is a block diagram illustrating an example of HRP over HTTP proxies in an IP network;

FIG. 20 illustrates an example of HRP JSON encoding for capability and/or configuration information;

FIG. 21 illustrates an example of HRP JSON encoding for key-range reachability;

FIG. 22 is a block diagram illustrating an example of HRP Peering within a lookup-by-name based information centric networking (ICN) system;

FIG. 23 is a block diagram illustrating an example of summary-routing based peering (SRP) routing;

FIG. 24 is a message flow diagram illustrating an example SRP message flow; and

FIG. 25 illustrates a BGP Extension for SRP Reachability Information.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

Example Communications System

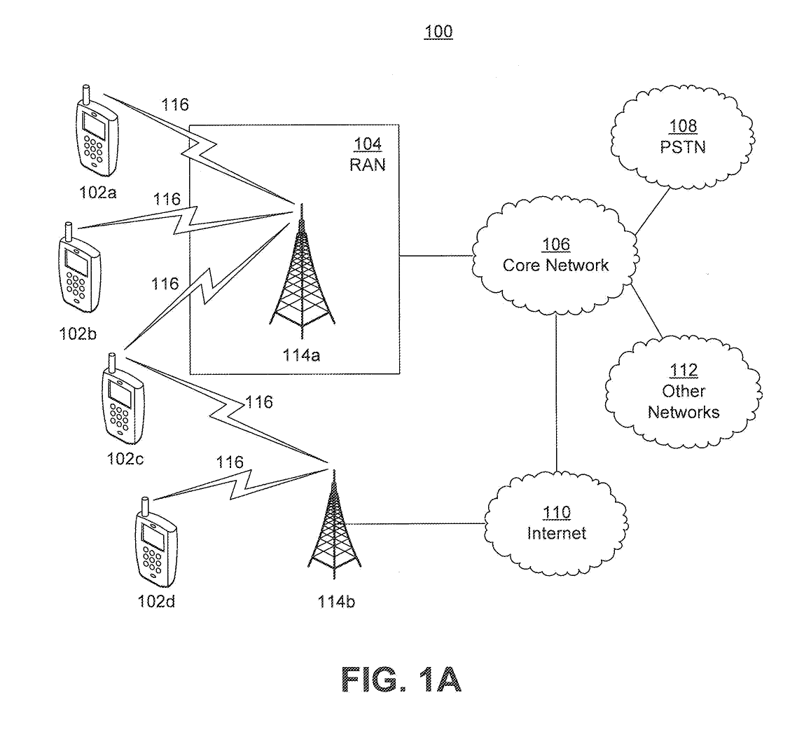

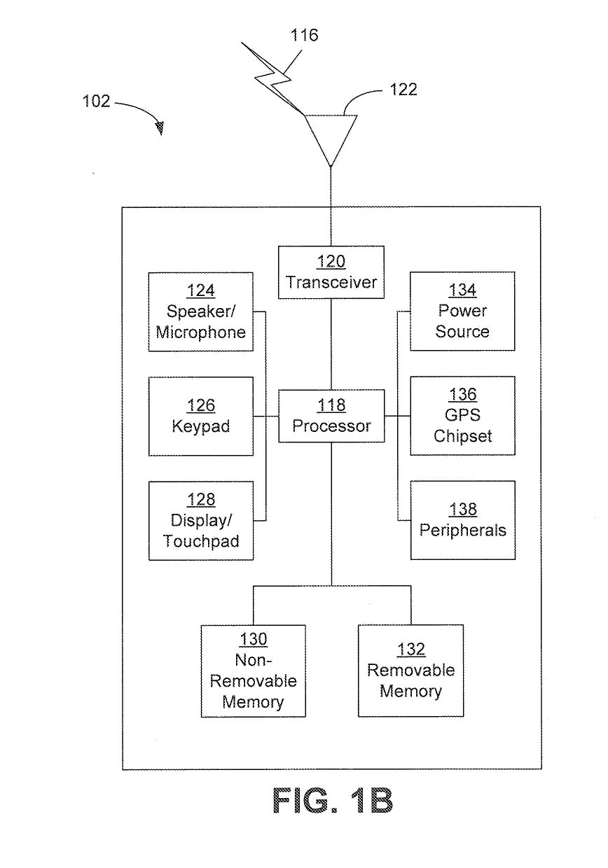

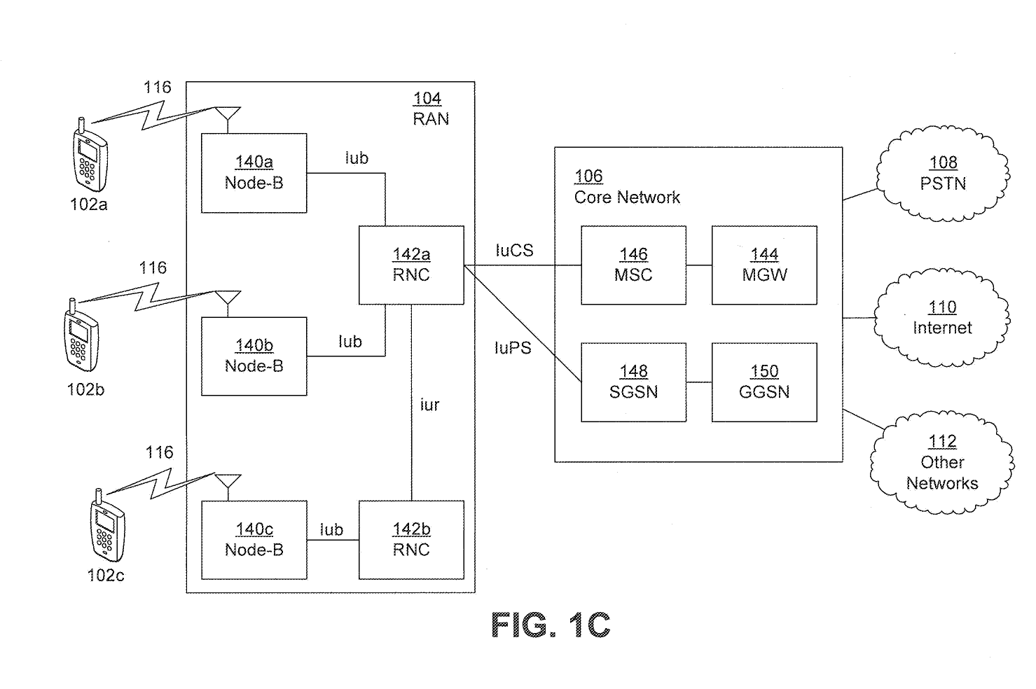

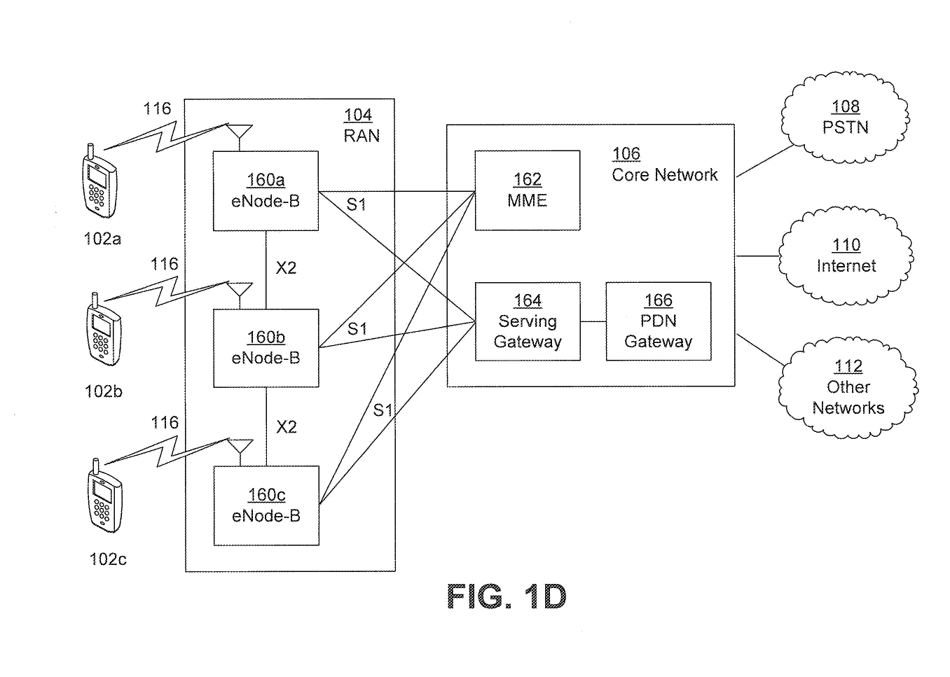

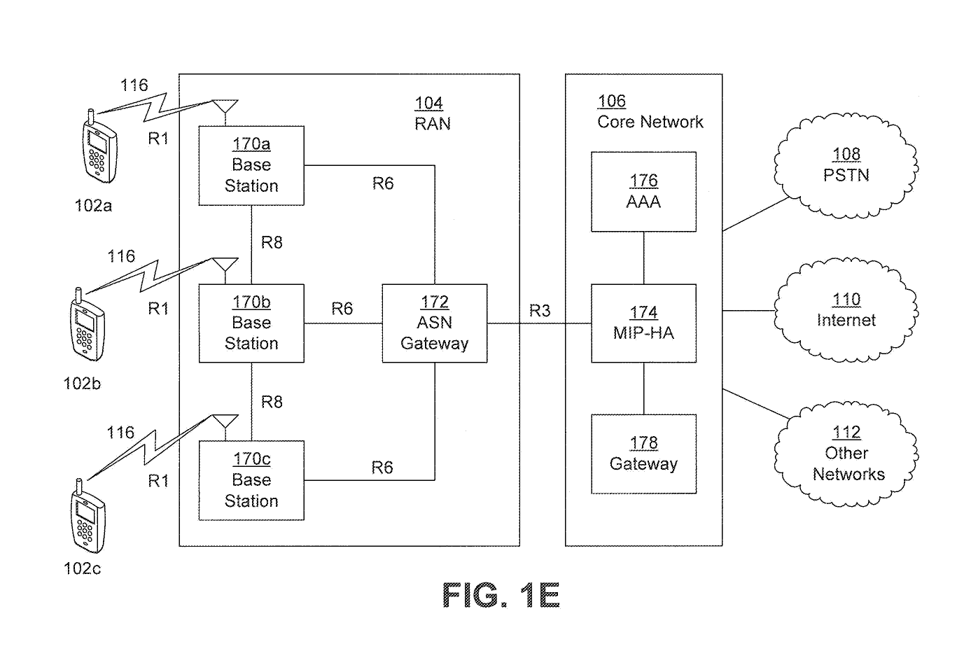

The methods, apparatuses and systems provided herein are well-suited for communications involving both wired and wireless networks. Wired networks are well-known. An overview of various types of wireless devices and infrastructure is provided with respect to FIGS. 1A-1E, where various elements of the network may utilize, perform, be arranged in accordance with and/or be adapted and/or configured for the methods, apparatuses and systems provided herein.

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals, and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, a terminal or like-type device capable of receiving and processing compressed video communications, or like-type device.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, a media aware network element (MANE) and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and receive wireless signals from, the WTRU 102a.

Each of the eNode Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode Bs 160a, 160b, 160c may communicate with one another over an X2 interface.

The core network 106 shown in FIG. 1D may include a mobility management gateway (MME) 162, a serving gateway (SGW) 164, and a packet data network (PDN) gateway (PGW) 166. While each of the foregoing elements are depicted as part of the core network 106, it will be appreciated that any one of these elements may be owned and/or operated by an entity other than the core network operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular SGW during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The SGW 164 may also be connected to the PGW 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 102c.

As shown in FIG. 1E, the RAN 104 may be connected to the core network 106. The communication link between the RAN 14 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 11, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Overview

This disclosure is drawn, inter alia, to methods, apparatus, systems, devices, and computer program products directed to enabling federation of multiple independent networks through hash-routing based peering (HRP) and/or summary-routing based peering (SRP). Pursuant to new methodologies and/or technologies provided herein the multiple independent networks may self-organize, or otherwise assemble, as a federation of network peers.

The network peers may cooperate to pool and/or merge resources (e.g., backhaul and/or caching resources) to make available for the federation some population (or amount) of content objects. As members of the federation, each of the network peers may undertake responsibility for making available to (at least some of) other network peers a share of the population (or amount) of content objects. To facilitate this, the multiple independent networks may establish connectivity and may federate using a routing-based peering protocol. The routing-based peering protocol may be an HRP protocol. Pursuant to the HRP protocol, the network peers may allocate amongst themselves respective partitions (“key ranges”) within a hash-value space (e.g. [0;2ⁿ[ interval) of a hash function (e.g., a MD5, etc.). The network peers may employ an allocation strategy (e.g., a partition function) to guide allocation of the hash-value space.

When one of the network peers receives a content request from a local end user, local router or another network, the network peer may route and/or forward the content request over a backhaul or transit network or any link not part of the peering network if the content request falls into the content-object population allocated to this peer. Alternatively, the network peer route and/or forward the content request through another network peer for processing if a hash value calculated from the content request falls within a key range of a hash value space allocated to such network peer.

Intuitively, logically merging the multiple individual networks as a federation with the (logically) combined backhaul and/or caching resources of the network peers, should result in an efficiency gain because of a higher cache-hit ratio, since the merged caching resources supports a larger population. Federating the multiple individual networks using the HRP protocol enables such logical merging of caching storage capacity and transit (or backhaul) transfer capacity of the multiple individual networks.

Hash-Routing Based Peering for Content Network Federations

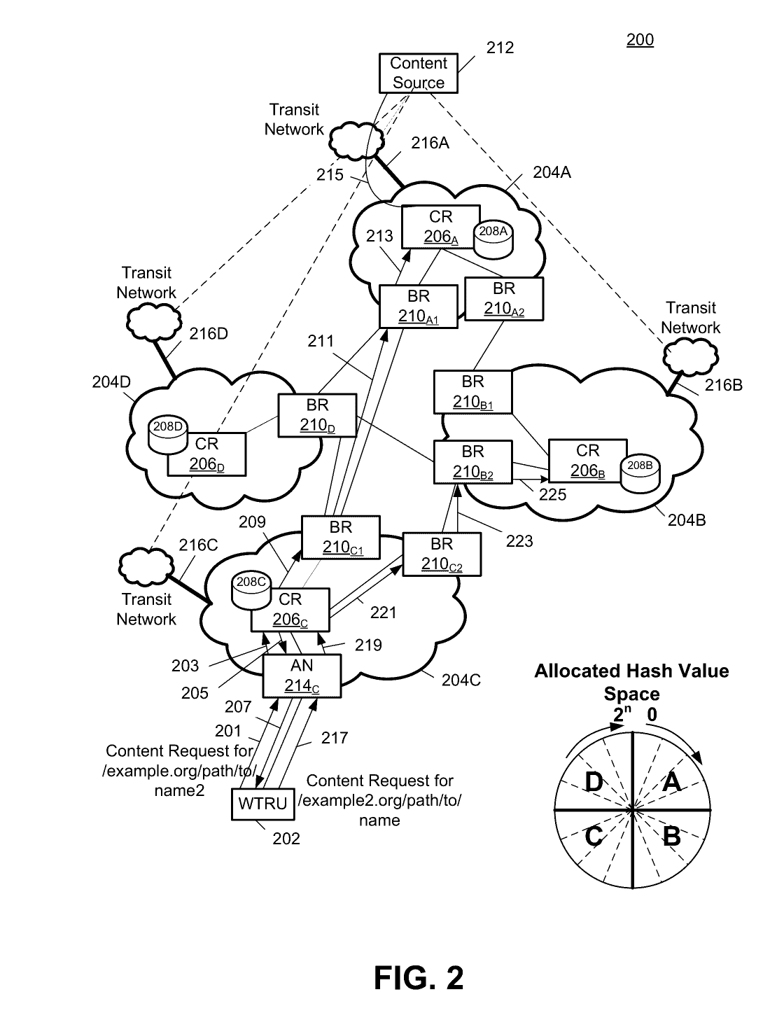

FIG. 2 is a block diagram illustrating an example network federation 200 in which one or more disclosed embodiments may be implemented. The network federation 200 may include network peer 204_{A}, network peer 204_{B}, network peer 204_{C} and network peer 204_{D} (collectively “network peers 204_{A-D}”). Each of the network peers 204_{A-D} may be, for example, any individual domain under control of, or otherwise operated by, an operating entity (“network operator”); examples of which may include any of an internet service provider (ISP) network, a single small cell, a small cell network, etc. In some embodiments, the network peers 204_{A-D} may be operated by the same network operator. In other embodiments, some or all of the network peers 204_{A-D} may be operated by different network operators.

The network peer 204_{A} may include a content router 206_{A} communicatively coupled with two border routers 210_{A1}, 210_{A2}. The network peer 204_{B} may include a content router 206_{B} communicatively coupled with two border routers 210_{B1}, 210_{B2}. The network peer 204_{C} may include an access node (e.g., an access point) 214_{C} communicatively coupled with a content router 206_{C}, which in turn, is communicatively coupled with two border routers 210_{C1}, 210_{C2}. The network peer 204_{D} may include a content router 206_{D} communicatively coupled with a border router 210_{D}.

Each of the network peers 204_{A/B/C/D} may also include other various network resources, including a transit network 216_{A/B/C/D} and a local cache 208_{A/B/C/D}. Each transit network 216_{A/B/C/D} may provide its network peer 204_{A/B/C/D} with some amount of transit (backhaul) transfer capacity and/or other backhaul resources. Each local cache 208_{A/B/C/D} may provide its network peer 204_{A/B/C/D} with some amount of caching storage capacity and/or other caching resources. The local caches 208_{A-D}, for example, may store one or more content objects obtained from one or more content sources (shown collectively as “content source 212”).

The local caches 208_{A-D} may be collocated, integrated or otherwise combined with the content routers 206_{A-D}, respectively. Alternatively, the local caches 208_{A-D} may be separate elements of the network peers 204_{A-D}, respectively; and the content routers 206_{A}, 206_{B}, 206_{C} and 206_{D} may communicatively couple with the local caches 208_{A}, 208_{B}, 208_{C}, and 208_{D}, respectively. The network peers 204_{A}, 204_{B}, 204_{C} and 204_{D} may exchange (e.g., send and/or receive) content request messages and/or content response messages with the transit networks 216_{A}, 216_{B}, 216_{C} and 216_{D}, respectively, to retrieve one or more content objects from the content source 212.

Although not shown, each of the network peers 204_{A-D} may include more than one content router and more than one local cache. Each of the network peers 204_{A}, 204_{B} and 204_{D} may include one or more access nodes. The network peers 204_{C} may include more or fewer access nodes. The network peers 204_{A}, 204_{B} and 204_{C} may include more or fewer than two border routers, and the network peer 204_{D} may include more than one border router.

To facilitate cooperation among the network peers 204_{A-D}, such network peers may establish connectivity to one another. Such connectivity may be established using any topology, e.g., full mesh, partial mesh, hub, etc. Interconnections providing the connectivity may use an underlying transport network, such as an internet. The border routers 210_{A1} and 210_{C1} may interconnect network peers 204_{A} and 204_{C}. The border routers 210_{A2} and 210_{B1} may interconnect network peers 204_{A} and 204_{B}. The border routers 210_{B1} and 210_{C2} may interconnect network peers 204_{B} and 204_{C}. The border routers 210_{C1} and 210_{D} may interconnect network peers 204_{C} and 204_{D}. The border routers 210_{B2} and 210_{D} may interconnect network peers 204_{B} and 204_{D}, and the border routers 210_{A1} and 210_{D} may interconnect networks 204_{A} and 204_{D}. Pursuant to the interconnections, communications emanating from one of the network peers 204_{A-D} may be single hop away from another.

The content router 206_{C} and the access node 214_{C} may exchange messages based on a route-by-name (such as for example, a route-by-name information centric networking (ICN)) protocol or like-type protocol. The content routers 206_{A}, 206_{B} and 206_{D} and access nodes of networks 204_{A}, 204_{B} and 204_{D}, respectively, may exchange messages based on a route-by-name or like-type protocol.

The network peers 204_{A-D} may cooperate with respect to sharing responsibility for fetching and/or serving content objects to satisfy content requests handled by such network peers. To facilitate this, the content routers 206_{A-D} may establish a peering network using a routing-based peering protocol. In some embodiments, this routing-based peering protocol may be the HRP protocol. Pursuant to the HRP protocol, the content routers 206_{A-D} may allocate amongst themselves respective key ranges within a hash-value space of a hash function (e.g., a MD5, etc.).

The content routers 206_{A-D} may employ an allocation strategy (e.g., a partition function) to guide allocation of the hash-value space. An appropriate allocation strategy may be to allocate the hash-value space equally among the network peers 204_{A-D} using a partition function, associating a network peer ID to any hash values within the [0;2ⁿ[ interval, where n is selected to provide a suitable key range granularity. As an example, n may be 4, and the partition function may associate (i) hash values within [0-4[ to network peer 204_{A}, (ii) hash values within [4-8[ to network peer 204_{B}, (iii) hash values within [9-12[ to network peer 204_{C}, and (iv) hash values within [9-12[ to network peer 204_{D}. A visual representation of the example allocation strategy is shown in FIG. 2 as a segmented disk 218.

Other allocation strategies may include not allocating the entire hash-value space and/or certain key ranges. As described in more detail below, the content routers 206_{A-D} may exchange messages to negotiate and/or converge upon the allocation of the key ranges.

Each of the content routers 206_{A-D} may maintain a routing table or other data structure (“HRP routing table”). The HRP routing table may include peering information (“HRP peering information”) associated with each of the network peers 204_{A-D}. The peering information may include an identity (“network-peer ID”) of each of the network peers 204_{A-D}, and in connection with each of the network-peer IDs, any key range allocated to the identified network and/or next hop information (e.g., a locator of a next hop router).

Any of the content routers 206_{A-D} may determine which network peer 204_{A/B/C/D} is responsible for processing a particular content request (“responsible peer”) based on its HRP peering information, the content request, and the hash function used for HRP peering of the network peers 204_{A-D}. By way of example, the content router 206_{C} may obtain a hash value calculated using the hash function and the content request. The content router 206_{C} may determine whether any of the allocated key ranges in the HRP peering information has a hash value matching the obtained hash value. If a match is found, then the content router 206_{C} may obtain a network-peer ID maintained in connection with the key range having the matching value, which network-peer ID may identify the responsible peer.

The content router 206_{C} may route and/or forward the content request through the responsible peer if the network-peer ID does not match the network-peer ID of network 204_{C}. The content router 206_{C} may fulfill the content request by retrieving the requested content object from the local cache 208_{C} or from the content source if the network-peer ID matches the network-peer ID of network 204_{C}.

In some embodiments, the content router 206_{C} may check whether the content request can be fulfilled from the local cache 208_{C} without first determining which of the network peers 204_{A-D} is the responsible peer. If the check indicates that the requested content is available from the local cache 208_{C}, then the content router 206_{C} may fetch the requested content object from the local cache 208_{C}.

In some embodiments, the operator(s) of the network peers 204_{A-D} may enter into a peering agreement or other peering arrangement (collectively “peering agreement”) to facilitate the cooperation and/or peering. Pursuant to the peering agreement, the network peers 204_{A-D} may agree to make available to the network peers 204_{A-D} some amount or population of content objects, and each of the network peers 204_{A-D} may undertake responsibility for making available to the other network peers some share of the amount or population of content objects. The peering agreement may specify that the peer networks 204_{A-D} may employ the HRP protocol. Such peering agreement (“HRP peering agreement”) may specify, inter alia, the hashing function and the allocation strategy. Alternatively, the HRP peering agreement may specify multiple hashing functions and multiple allocation strategies from which the network peers 204_{A-D} (or operators thereof) may select from and/or converge upon. The HRP peering agreement might not specify the hashing function and the allocation strategy; leaving selection and/or negotiation of a suitable hashing function and a suitable allocation strategy to the network peers 204_{A-D} (or operators thereof).

In some embodiments, the network peers 204_{A-D} may be configured with the HRP protocol (e.g., as a standard protocol). Each of the network peers 204_{A-D} may use a discovery process to discover content routers that employ the HRP protocol (each an “HRP router”), and may form the interconnections between the HRP routers and border routers (collectively “peering links”) to establish the peering network (“HRP peering network”).

FIG. 2 also illustrates an example routing operation within the network federation 200. A WTRU 202 may send a content request message toward network 204_{C} to request a content object (201). The content request message may include a content descriptor. The content descriptor may be any of (i) a name of the content object (“content-object name”), (ii) metadata associated with content object (“content-object metadata”), and (iii) one or more attributes of the content request message (“content-request-message attributes”). The content-object name may be, for example, a uniform resource identifier (URI) of the content object. Alternatively, the content-object name may be a hierarchal name of the content object; an example of which is shown in FIG. 2, namely, “/example.org/path/to/name2”.

The access node 214_{C} may receive the content request message sent from the WTRU 202 (201), and may forward the content request message toward the content router 206_{C} (203). The content router 206_{C} may receive the content request message (203), and may determine, based on the content descriptor or an alias (e.g., hash value) thereof, the local cache 208_{C} includes a local copy of the content object. The content router 206_{C}, in turn, may forward the content request message to the local cache 208_{C}. The local cache 208_{C} may receive the content request message, retrieve the local copy of the content object, and fulfill the request by sending back to the content router 208_{C} a content response message including the local copy of the content object. The content router 206_{C}, in turn, may forward the content response message to the WTRU 202, via the access node 214_{C} (205, 207).

In some embodiments, the local cache 208_{C} may drop the content request and/or respond with a negative acknowledgement (NACK) if it is unable to retrieve the local copy of the content object. The local cache 208_{C} might be unable to retrieve the local copy of the content object for various reasons, such as, for example, the local cache 208_{C} lacks a local copy of the content object and/or a local copy cannot be located in (and/or provided from) the local cache 208_{C}.

The content router 206_{C}, when unable to utilize the local cache 208_{C} to fulfill the content request, may look to utilize other resources inside and/or outside the domain as an alternative. The content router 206_{C}, for example, can determine whether to utilize any of the other network peers 204_{A}, 204_{B}, and 204_{D} in lieu of utilizing the backhaul resources of network peer 204_{C}, as follows. The content router 206_{C} may hash the content descriptor using the hash function and obtain a hash value of the content descriptor (“descriptor-hash value”). Alternatively, the content router 206_{C} may extract the descriptor-hash value from content request message, if available. Then, the content router 206_{C} may search its HRP routing table to identify any of the allocated key ranges that include a hash value matching the descriptor-hash value. If no match is found, then the content router 206_{C} may default to utilizing the backhaul resources of network peer 204_{C} to fulfill the content request. If a match is found, then the content router 206_{C} may utilize the network peer 204_{A/B/D} matching the network-peer ID maintained in connection with the identified key range. Multiple matches may be resolved using criteria in addition to the identified key range (e.g., cost information).

In the example shown, the content router 206_{C} determines that the network peer 204_{A} may be utilized, and as such, it may route the content request message through the network peer 204_{A} for processing. The content router 206_{C}, based on this determination, may forward the content request message towards the border router 210_{C1} (209). To facilitate forwarding of the content request message, the content router 206_{C} may refer to routing entries in a forwarding information base (FIB). These routing entries may include, for example, the responsible peer network-IDs, Output-interface, next hop, etc.

The border router 210_{C1} may receive (209), and then forward the content request message towards the peer network 204_{A} (211). The border router 210_{A1} may receive the content request message (211), and may forward it to the content router 206_{A} (213). The content router 206_{A} may receive the content request message (213), and may determine, based on the content descriptor, descriptor-hash value and/or some other alias thereof, the local cache 208_{A} includes a local copy of the content object. The content router 206_{A}, in turn, may forward the content request message to the local cache 208_{A}. The local cache 208_{A} may receive the content request message, retrieve the local copy of the content object, and fulfill the request by sending back to the content router 208_{A} a content response message that includes the local copy of the content object. The content router 206_{A}, in turn, may forward content response message to the WTRU 202, via the border routers 210_{A}, 210_{C1}, the content router 206_{C} and the access node 214_{C}.

In some embodiments, the local cache 208_{A} may drop the content request and/or respond with a negative acknowledgement (NAck) if it is unable to retrieve the local copy of the content object. The local cache 208_{A} might be unable to retrieve the local copy of the content object for various reasons, e.g., as described above.

The content router 208_{A}, being aware that network peer 204_{A} is the responsible peer and that it is unable to fulfill the content request from the local cache 208_{A}, may send the content request message to the original content source, via transit network 216_{A}, to fetch the content object from the original content source (215). The original content source may receive the content request message and retrieve the content object. Although not shown, the original content source may return the content object to the content router 206_{A}.

After receiving the content object, the content router 206_{A} may respond to the content request message by sending to the WTRU 202, via a return path, a content response message including the content object fetched from the content source (not shown). The content object fetched from original content source may be stored (e.g., by the content router 206_{A}) in the local cache 208_{A}, as well. Although the network peer 204_{C} is not the responsible peer, the content object may be stored in the local cache 208_{C} (e.g., with a low priority). Alternatively, the network peer 204_{C} might not cache the content object.

The WTRU 202 may send another content request message toward network 204_{C} to request a different content object (217). The access node 214_{C} may receive the content request message (217), and may forward the content request message to the content router 206_{C} (219). The content router 206_{C} may receive the content request message (219). After determining it is unable to utilize the local cache 208_{C} to fulfill the content request, the content router 206_{C} router may look to utilize other resources inside and/or outside the domain. The content router 206_{C} may determine, the same way as described above, that the network peer 204_{B} may be utilized and as such, it may route the content request message through the network peer 204_{B} for processing. The content router 206_{C}, based on the determination, may forward the content request message towards the border router 210_{C2} (221). To facilitate forwarding of the content request message, the content router 206_{C} may refer to routing entries in the FIB.

The border router 210_{B2} may receive (221), and then forward the content request message towards the peer network 204_{B} (223). The border router 210_{B2} may receive the content request message (223), and may forward it to the content router 206_{B} (225). The content router 206_{B} may receive the content request message (225), and may determine, based on a content descriptor, a descriptor-hash value and/or some other alias thereof, the local cache 208_{B} includes a local copy of the content object. The content router 206_{B}, in turn, may forward the content request message to the local cache 208_{B}. The local cache 208_{B} may receive the content request message, retrieve the local copy of the content object, and fulfill the request by sending back to the content router 208_{B} a content response message that includes the local copy of the content object. The content router 206_{B}, in turn, may forward content response message to the WTRU 202, via the border routers 210_{B2}, 210_{C2}, the content router 206_{C} and the access node 214_{C}.

Although not shown, if the content router 206_{C} determines that its network peer 204_{C} is the responsible peer or that none of the other peer networks 204_{A}, 204_{B} and 204_{D} is the responsible peer for the requested content objects, the content router 206_{C} may fetch such content objects from the original content source via the transit network 216_{C}, and may send to the WTRU 202 (via the access node 214_{C}) content response messages including the corresponding content objects fetched from original content source. The content objects fetched from original content source may be stored in the local cache 208_{C}.

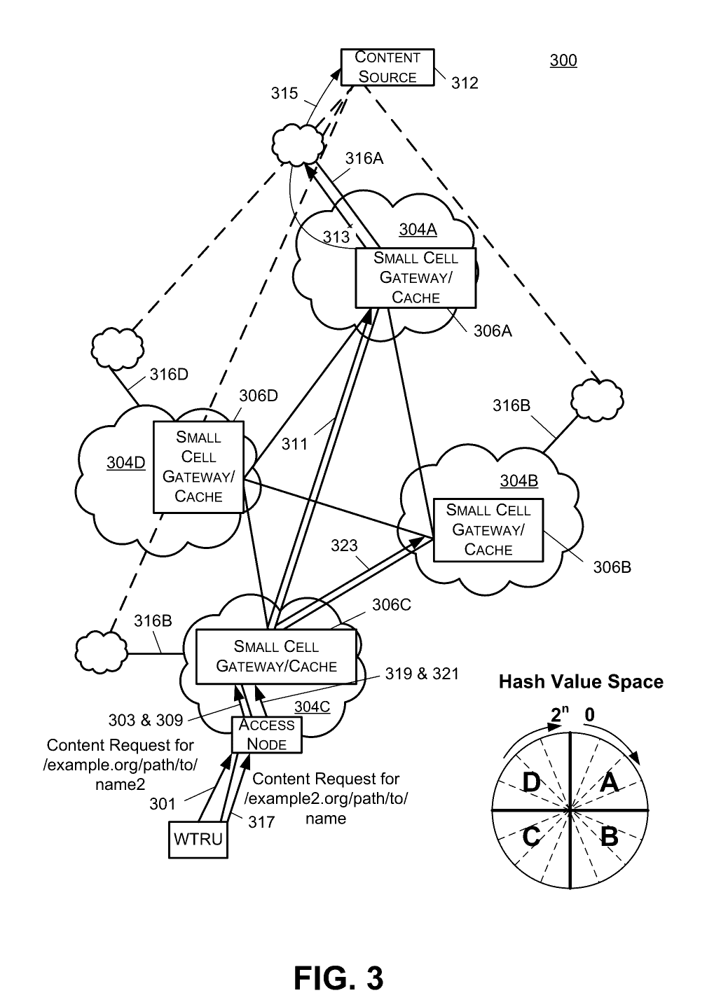

FIG. 3 is a block diagram illustrating an example network federation 300 in which one or more disclosed embodiments may be implemented. The federation 300 of FIG. 3 is similar to the federation 200 of FIG. 2 in most aspects. For example, the federation 200, the federation 300 may include four network peers, namely, small cell peer 304_{A}, small cell peer 304_{B}, small cell peer 304_{C} and small cell peer 304_{D} (collectively “small cell peers 304_{A-D}”); and the small cell peers 304_{A-D} may be operated by a single or by multiple operators.

The small cell peers 304_{A-D} may include respective gateways 306_{A-D}. Each of the gateways 306_{A-D} may include functionality to operate as a combined local cache, HRP router and border router. Such functionality may be akin to the combined functionality of the local cache 208_{C}, content router 206_{C} and border router 210_{C1} of network peer 204_{C} (FIG. 2), for example. Each of the gateways 306_{A-D} may use edge caching as a way to reduce backhaul usage. Since backhaul links are expensive, the operator(s) may desire to further reduce backhaul usage. This may be accomplished, in part, by deploying peer-to-peer links between the small cell peers 304_{A-D}. The peer-to-peer links may be wired and/or wireless links, and may be assumed to have a low cost of deployment and operation (at least compared with the backhaul links). Each of the small-cell-peer caches may be configured with, or combined with, a content router. The HRP router functionality of the gateways 304_{A-D} may cause (i) the small cell peers 304_{A-D} to cooperate so as to (i) pool and/or merge caching and/or backhaul to make available to the federation 300 some amount or population of content objects, and/or (ii) each of the small cell peers 304_{A-D} to undertake responsibility for making available to the remaining small cell peers 304_{A-D} some share of the amount or population of content objects. After key ranges of the hash-value space are allocated, content objects may be handled (for fetching from backhaul and for caching) by the responsible small cell peer (noting that the small cell peer that receives the content request from a WTRU may not be the responsible peer).

A source of gain may result and/or stem from the local caches of the small cell peers 304_{A-D} being logically merged. This, in turn, may result in the end user base of the merged cache being 4 times larger; increasing probabilities (in a typical setting) for a higher cache-hit ratio. Additionally and/or alternatively, capacity requirements on one or more of the backhaul links may be reduced.

FIG. 3 also illustrates an example routing operation within the network federation 300. The operation illustrated in FIG. 3 is similar to the operation illustrated in FIG. 2, except that each of the small cell peers 304_{A-D} handle internally local cache processing, HRP routing and border routing for content requests (as shown, for example, combined reference numbering).

Although not shown, the network operator(s) may deploy a new small cell peer. Due to technical constraints, the network operator can interconnect the new small cell peer to small cell peers 304_{A}, 304_{C}, but not to small cell peers 304_{B}, 304_{D}. The inclusion of the small cell peer in the peering network makes the peering interconnection a partial mesh. The partial mesh may cause an increase in complexity of forwarding decisions within the new small cell peer and the small cell peers 304_{A-D}. For example, the new small cell peer may learn the allocated key ranges of the small cell peers 304_{A}, 304_{C}, and may forward relevant content requests through them. The new small cell peer may or may not send certain content request towards the small cell peers 304_{B}, 304_{D}, because it may be less efficient due to the content request having to pass through the small cell peer 304_{A} or small cell peer 304_{C} and use more network resources. The new small cell peer may advertise to the small cell peers 304_{A} and/or 304_{C} some or all key ranges that the small cell peers 304_{B} and/or 304_{D} are responsible for. The small cell peers 304_{A} and/or 304_{C} may forward some of their content requests through the new small cell peer for the advertised key ranges. The foregoing illustrates that HRP may provide hash-routing based optimization for complex and evolving networks.

HRP Agreement

Pursuant to an HRP agreement, each network peer may provide an indication of an amount of transit bandwidth and/or an indication of an amount of caching capacity the network peer plans provide (e.g., contribute) to the peering network. Alternatively, each network peer may provide a weight indicative of the amount of transit bandwidth and/or the amount of caching capacity the network peer plans provide to the peering network. The weight may be provided in lieu of the indications of the amount of transit bandwidth and/or the amount of caching capacity. The network peer may provide such weight, for example, where an operator does not wish to expose transit and caching information to the outside. The transit and caching capacity provided to the peering agreement may represent all or part of the total capacity available to the peer network. The transit capacity provided to the peering agreement might exclude backhaul/transit link capacity reserved (e.g., by the network operators) for other types of traffic.

The peering agreement may include details for provisioning of peering links between peers. These peering links may be peer-to-peer links (e.g. an Ethernet cable, a wireless peer-to-peer link), and/or an exchange point. The exchange point may be transparent (e.g. an Ethernet switch). Alternatively, the exchange point may possess some or all the HRP functionality. Such exchange point may include, for example, an HRP router.

The HRP agreement may include a description for one or more of the peering links. The description may include a topology of the link (e.g., peer-to-peer, transparent hub, HRP enabled hub), and/or a capacity of each link (e.g. independent capacity for P2P links, or combined capacity for hub links). Example HRP agreement data is listed below in Table 1.

TABLE 1

| | |
|---|---|
| Contributed Transit | Contributed Caching |
| Bandwidth (Gbps) | Capacity (TBytes) |

Peer list

| | | |
|---|---|---|
| A | 10 | 10 |
| B | 10 | 100 |
| C | 5 | 10 |

Link list

| | | |
|---|---|---|
| Hub (A, B, C) | 10 Gbps | 5 |
| Supplemental P2P link A-B | 5 Gbps | 0 |

The HRP peering agreement may include caching preference, e.g., whether a network peer responsible for a content object should cache it in its network if possible, and whether a network peer not responsible for a content object should either not cache it, or cache it with lower priority. A combination of routing and caching preference, based on hash value, makes it possible to globally optimize backhaul/transit usage and/or cache hit ratio across a peering network.

HRP Routing Overview

HRP routing may be distributed among multiple network peers using HRP routing elements thereof. Alternatively, HRP routing may be centralized (e.g., concentrated) on a single network peer using HRP elements thereof (e.g., a HRP controller), or on a network element communicatively coupled to the network peers. HRP routing may be used to populate forwarding information (FIB) in HRP routers. Such forwarding information may be used to forward content requests received by the HRP routers. The HRP routing may include exterior HRP functions and interior HRP routing functions. The exterior HRP routing functions (“exterior HRP routing”) may be carried out by HRP peers, and may include allocating the key ranges. The interior HRP routing functions (“interior HRP routing”) may be carried out by entities within a single network peer, and may include routing content requests towards an appropriate border router.

In an ICN setting, HRP routing may be performed in ICN routers. The ICN routers may be disposed in (i) various peer networks, (ii) a central HRP router collocated with a peering hub, and/or or (iii) a WTRU. In an IP setting, HRP routing may be performed in HTTP proxies, for example. The HTTP proxies may be located in (i) peer networks, (ii) a central HTTP proxy collocated with a peering hub, and/or (iii) a UE.

HRP routing may involve populating and/or updating (collectively “maintaining”) routing information and/or routing rules in a data structure (“HRP routing table”) maintained by routers. Maintenance of the HRP routing table may be performed through distributed means (e.g., the HRP routing protocol) or centralized means (e.g. a HRP controller).

Table 2 (below) includes example labels and entries of an example of the HRP routing table. The labels and entries may be representative of a HRP routing table of the HRP router 206_{C} (FIG. 2) and/or HRP router of gateway 306_{B} (FIG. 3). The next hop entries for target networks 204/304_{A} and 204/304_{B} are the same (i.e., the value is “5.6.7.8”). The entries are the same because value “5.6.7.8” corresponds to the HRP router 206_{B} (network 204/304_{B}), and the HRP router 206_{A} (network 204304_{A}) is reachable through network 204/304_{B} (as determinable from the HRP cost entries).

TABLE 2

| | | | | HRP Cost (e.g. |
|---|---|---|---|---|
| | | Target Network | | number of hops, |
| | | Label (maybe a | | monetary cost, |
| Table | | string, an IP | Next Hop | policy based |
| Entry | Key | address, an IP | (Locator of next | cost, or a mix of |
| Index | Range | subnet, etc.) | hop router) | those) |
| 1 | 0-4 | A | 5.6.7.8 | 2 |
| 2 | 4-7 | B | 5.6.7.8 | 1 |
| 3 | 5-15 | C | 127.0.0.1 (local | 0 |
| | | | host) | |

The HRP cost may be consistent with, or different from, conventional routing metrics. The HRP cost may be used by the HRP routers to discriminate between competing HRP entries. In some embodiments, the HRP cost may have a value indicative of peering and/or transit link load. This value may vary over time. For example: if the HRP router 206/306_{B} of network peer 204/304_{B} determines or is informed that its peering link to network peer 204/304_{A} is overused, network may increase the cost of the HRP route to key range 0-4 through network peer 204/304_{A}, from a value of 2 to a value of 3. The HRP router 206/306_{C} of network 204/304_{C} may decide not to select the HRP route to key range 0-4 through network peer 204/304_{A} based on a (e.g., local) policy indicating the HRP cost is not acceptable.

In some embodiments, the HRP routing may be associated with a conventional IP routing table. Tables 3 and 4 (below) may illustrate an example of a combined HRP and IP routing (“HRP/IP routing”) table approach. Table 3 includes example labels and entries of HRP routing information associated with IP routing information. The HRP/IP routing approach may be used, for example, in IP networks using HTTP caches, or when HRP is used in ICN settings that use an underlying IP routing.

TABLE 3

| | | | HRP Cost (e.g. |
|---|---|---|---|
| | | | number of hops, |
| | | | monetary cost, policy |
| Table Entry | Key | | based cost, or a mix |
| Index | Range | IP address of cache | of those) |
| 1 | 0-4 | 1.2.3.4 | 2 |
| 2 | 4-7 | 5.6.7.8 | 1 |
| 3 | 5-15 | 127.0.0.1 (local host) | 0 |

Table 4 includes example labels and entries of IP routing information related to IP information shown in Table 3. As indicated by this simplified routing table, the HRP router has 2 interfaces, and is directly connected to network peers on each of these interfaces. The HRP router is also connected to a distant network 1.2.3.0/24, where network peers 204/304_{A} HRP router/cache is located, through a directly connected network peer 204/304_{B} (5.6.7.8).

TABLE 4

| Table Entry Index | Destination Subnet | Next Hop Locator |
|---|---|---|
| 1 | 1.2.3.0/24 | 5.6.7.8 |
| 2 | 5.6.7.0/24 | Link Local (exterior |
| | | interface) |

An HRP routing table may have local significance in that each network peer may have a different HRP routing table. Difference of views may be unwanted, such as, for example, due to temporary de-synchronization between peers. The HRP routing protocol may be configured to correct the difference of views over time. Alternatively, the difference of views may be purposeful, such as, for example, due to multiple network peers being responsible for the same key range for load balancing or other purposes, and/or due to a network peer indicating some key ranges are unallocated, for instance, to avoid over-burdening a peer link.

In a distributed setting, where the HRP routing protocol is used, each network peer may, for example, start by allocating a small or nominal key range to itself. Then, over time, each network peer may gradually increase its allocation of key ranges. The network peers may continue increasing their respective allocations of the key ranges until, for example, congestion occurs or the entire hash-value space is allocated. The key range may be expressed as a portion of the entire hash-value space (e.g., 1/16^{th}). Expressing the key ranges in this way may make allocation simple, and may avoid fragmentation issues that might occur if allocated in other ways.

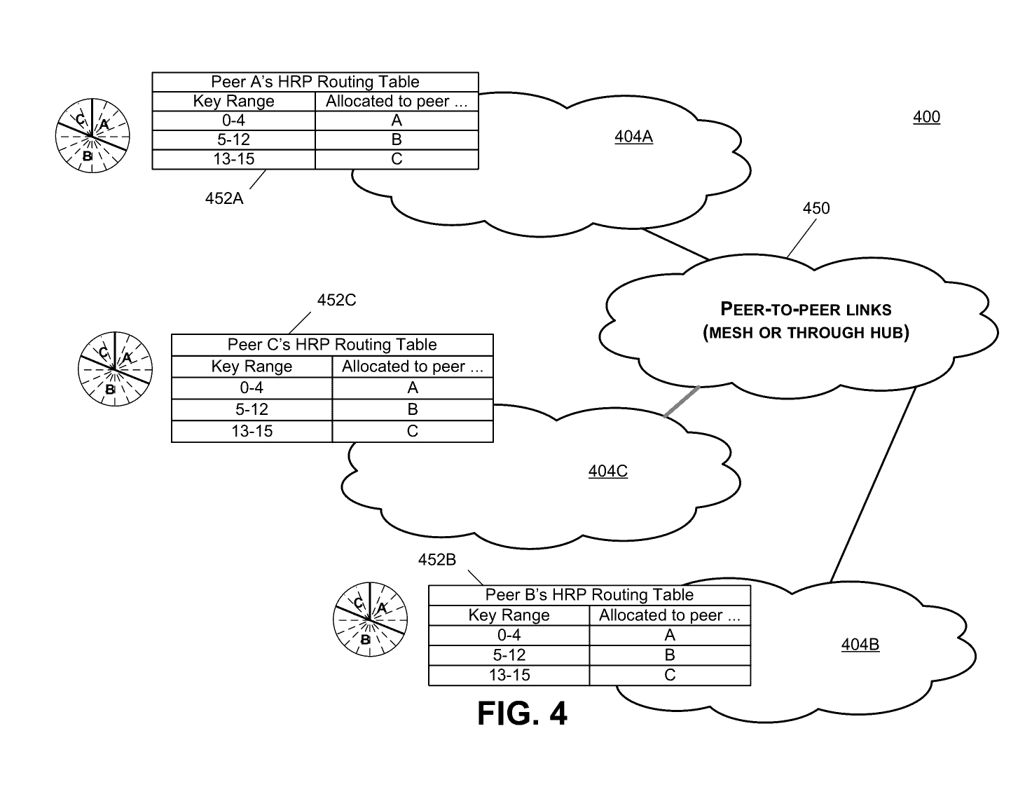

FIG. 4 is a block diagram illustrating an example federation 400 based on HRP. The federation 400 may include network peers 404_{A-C} communicatively coupled to each other via peer-to-peer links 450. HRP routing tables 452_{A-C} of network peers 404_{A-C}, respectively, may reflect a HRP routing state of its corresponding network peer 404_{A-C} under steady state conditions. Such steady state conditions may occur, for example, when key range allocation or re-allocation settles to, and remains in, a steady state. All of the HRP routing tables 452_{A-C} may include key ranges allocated to the network peers 404_{A-C} and network-peer IDs of the network peers 404_{A-C}. All of the network peers 404_{A-C} may see the same HRP routing state, such as shown in FIG. 4 (e.g., the entire hash value space is allocated to, and equally distributed among the network peers 404_{A-C}). The key ranges are expressed in [0-16[ indicating the hash-value space is partitioned into 16 blocks. Although simplified for illustration, each of the HRP routing tables 452_{A-C} may include additional information, such as, for example, next hop and/or cost information.

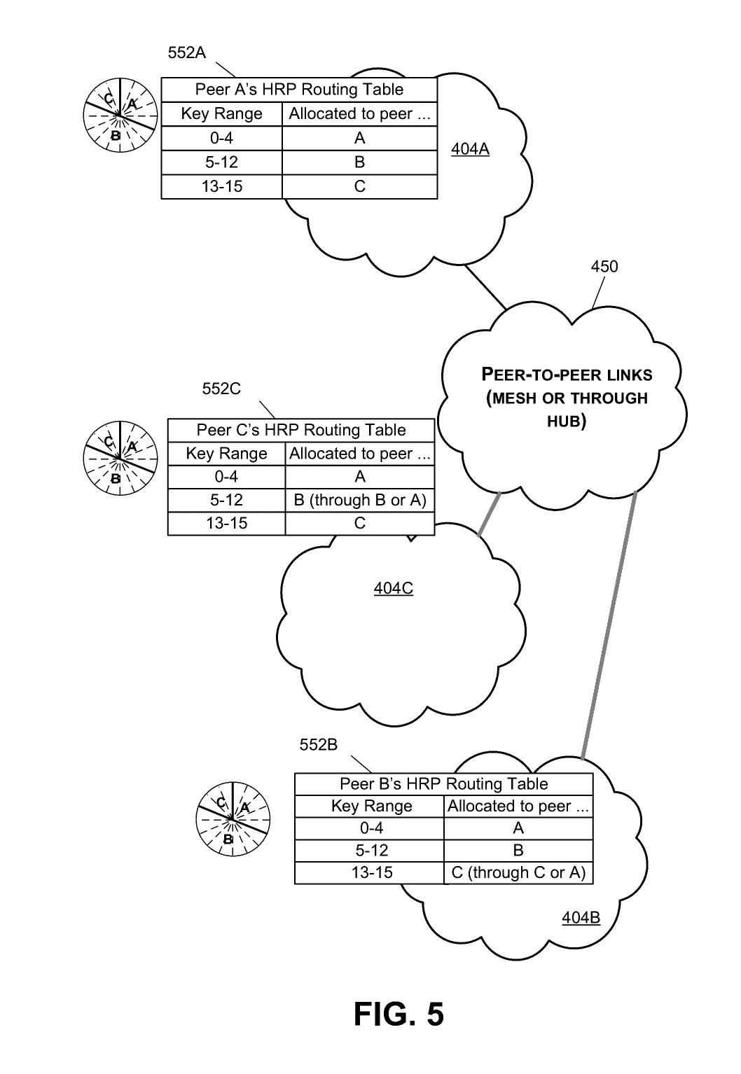

FIG. 5 is a block diagram illustrating example HRP routing tables 552_{A-C} of network peers 404_{A-C}. The HRP routing tables 552_{A-C} are similar to the HRP routing tables 452_{A-C}, except that the HRP routing tables 552_{B-C} have a HRP routing state that indicates that at least some of the content requests for blocks 5-12 and 13-15 exchanged between the network peers 404_{B} and 404_{C} may be routed through network peer 404_{A}. This HRP routing state may occur due to the peering link between the network peers 404_{B} and 404_{C} being over-utilized and due to the peering links between 404_{B} and 404_{A} and between 404_{C} and 404_{A} being under-utilized. Although simplified for illustration, each of the HRP routing tables 552_{A-C} may include additional information, such as, for example, next hop and/or cost information, and the single entry “A or B” may be implemented using 2 distinct entries, etc.

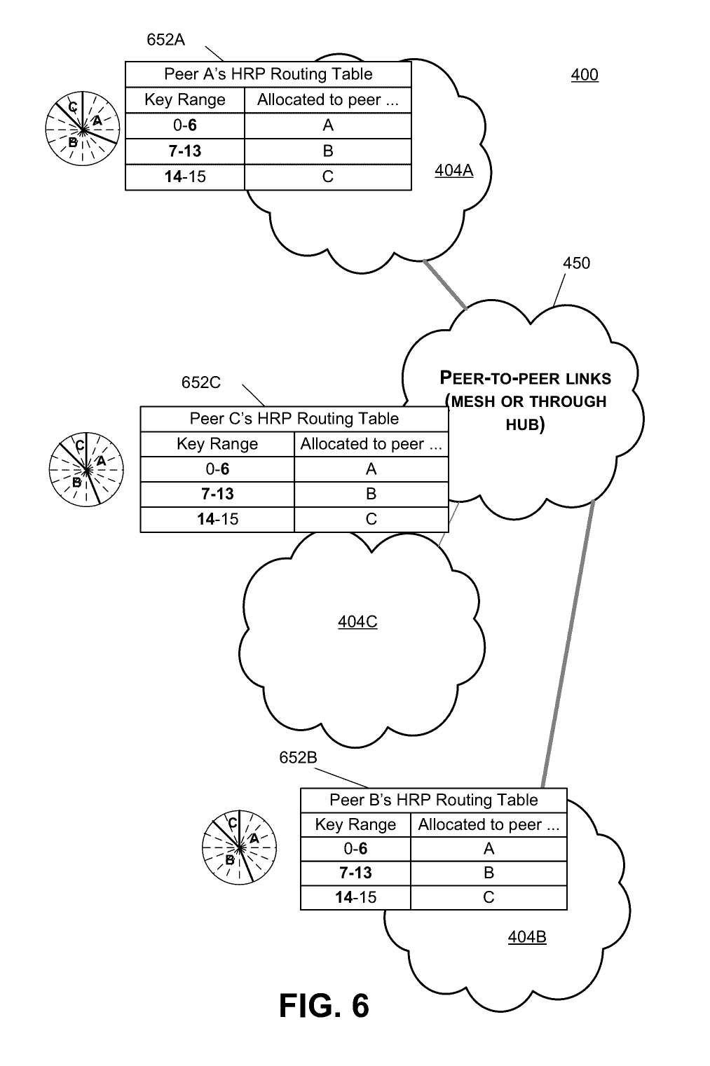

FIG. 6 is a block diagram illustrating example HRP routing tables 652_{A-C} of network peers 404_{A-C}. The HRP routing tables 652_{A-C} are similar to the HRP routing tables 452_{A-C}, except that the HRP routing tables 652_{A-C} have a HRP routing state that reflects transfers or re-allocation of key ranges among the network peers 404_{A-C} such that some of the blocks previously allocated to the network peers 404_{B-C} have been re-allocated to the network peers 404_{A}.

The HRP routing state of the HRP routing tables 652_{A-C} may occur due to the peering link between the network peers 404_{B} and 404_{C} being over-utilized and due to network peer 404_{A} having enough transit bandwidth and caching capacity (e.g., additional capacity could be added to network peer 404_{A} to 20 Gbps transit and 20 TB cache). Although simplified for illustration, each of the HRP routing tables may include additional information, such as, for example, next hop and/or cost information, etc.

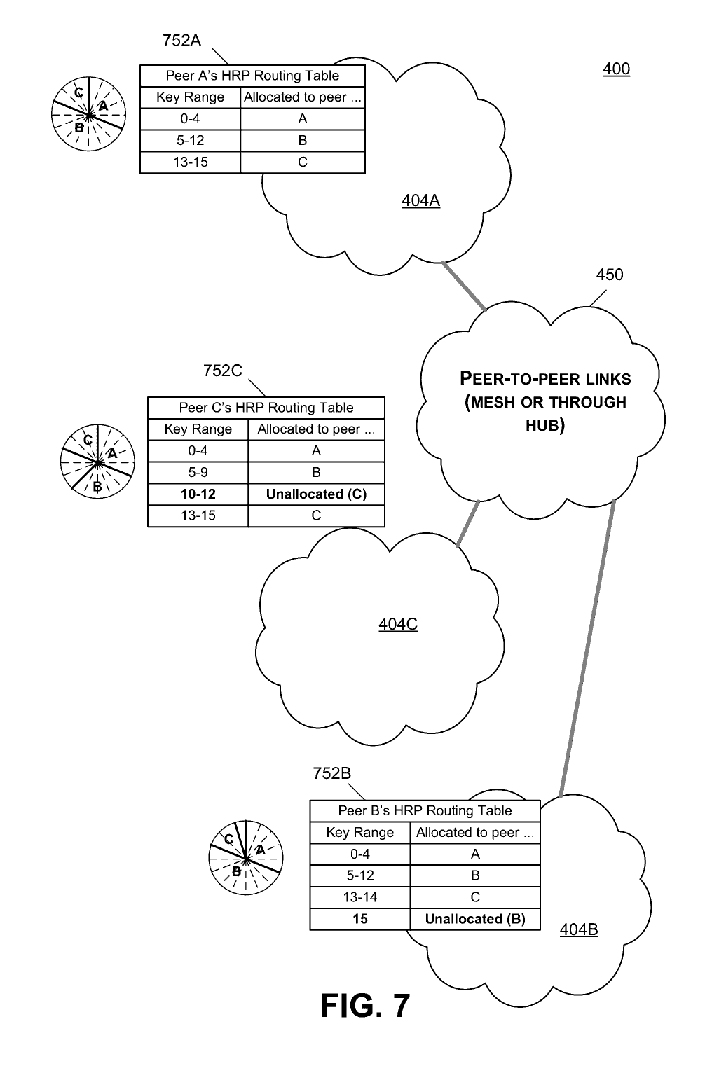

FIG. 7 is a block diagram illustrating example HRP routing tables 752_{A-C} of network peers 404_{A-C}. The HRP routing tables 752_{A-C} are similar to the HRP routing tables 452_{A-C}, except that the HRP routing tables 752_{A-C} have a HRP routing state that reflects that peer networks 404_{B} and 404_{C} might not send at least some of content requests to each other. The HRP routing state of the HRP routing tables 752_{A-C} may occur after network peers 404_{B} and 404_{C} detect congestion on a peering link between them, and consequently decide to remove some blocks from each other's allocation. The network peers 404_{B} and 404_{C} may select the blocks to remove using a deterministic approach (e.g., select the block with the highest index, etc.) to maximize cache hit ratio. For example, if the network peer 404_{A} decides to remove a block from a key range allocated to network peer 404_{C}, then the network peer 404_{A} removes block 15. This way, both of the network peers 404_{A}, 404_{B} can continue to use network peer 404_{C} for key ranges 13-14. Although simplified for illustration, each of the HRP routing tables may include additional information, such as, for example, next hop and/or cost information, etc.

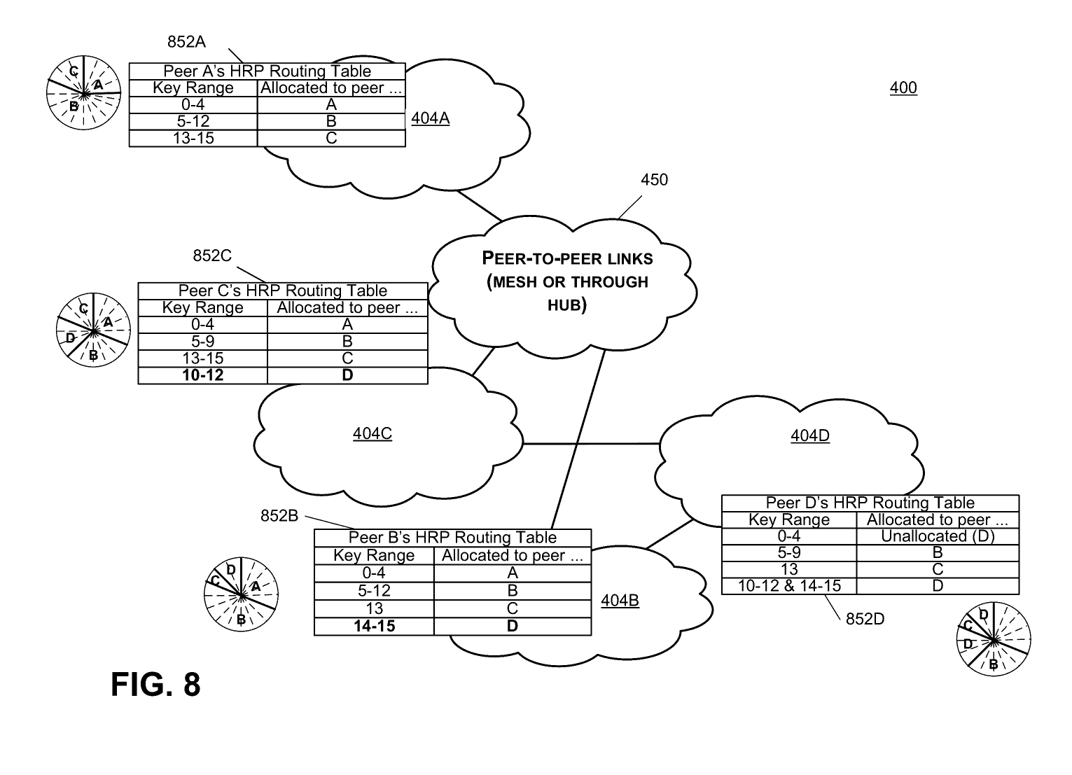

FIG. 8 is a block diagram illustrating example HRP routing tables 852_{A-C} of network peers 404_{A-C}. The HRP routing tables 852_{A-C} are similar to the HRP routing tables 452_{A-C}, except that the HRP routing state of the HRP routing tables 852_{A-C} reflects splitting key ranges allocation between different peers such that a portion of the key ranges originally allocated to network peers 404_{B} and 404_{C} are also allocated to network peer 404_{D}. The HRP routing state the HRP routing tables 852_{A-C} may occur due to the peering link between the network peers 404_{B} and 404_{C} being over-utilized and due to having network peer 404_{D} available or being able to add network peer 404_{D} to handle some key range blocks originally allocated to network peers 404_{B} and 404_{C}. Some of the network peers may be directed towards network peer 404_{D} for such blocks, while other network peers may use (or continue to use) network peers 404_{B} and 404_{C}. The HRP routing state the HRP routing tables 852_{A-C} is akin to a transfer of key ranges range described above, except that the key range is not de-allocated from its former responsible peer. The ability to carry out the transition may be especially useful for larger peering networks. Although simplified for illustration, each of the HRP routing tables may include additional information, such as, for example, next hop and/or cost information, etc.

Gain Evaluation

To estimate the gain from HRP, studies of a simplified use cases where all networks, backhaul links and peering links have exactly the same characteristics were performed. These use cases are based on the example topology from FIG. 2, showing 4 network peers having the same transit capacity, caching capacity and the same amount of traffic requested by end users. For the studies, the network peers only cache objects they have undertaken responsibility for with respect to the federation. Each network peer may cache other very popular content objects too, which may reduce peering link load in case of spikes (e.g. live streaming or “Slashdot effect”).

In one embodiment, all 4 network peers have a 10 Gbps downstream backhaul/transit link, and the content objects requested overall by the end users of network peer 204_{A} (resp. 204_{B}, 204_{C}, 204_{D}) are the same as the ones requested by end users of every other network. This reflects an extreme case of a 100% redundancy rate and that most of the traffic is from content requests from end users. The size of the request packets may be assumed to be negligible (e.g., as compared to the size of the content objects). By adding 5 Gbps point-to-point peering links between each of the network peers 204_{A-D}, and applying the procedures and techniques disclosed herein to the above-specified network conditions enables the network peers to provide the same network service may be with only 25% usage of backhaul/transit links at each of the network peer 204_{A-D}.

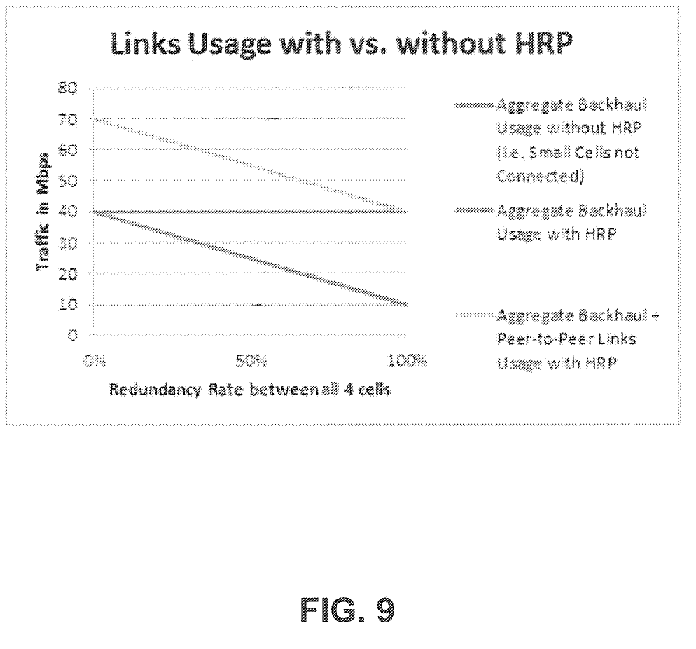

FIG. 9 is a graph illustrating example empirical ink usage with and without HRP. The graph may represent an evolution of the links usage with and without HRP for 4 cells with a 10 Gbps backhaul each, and full-mesh point-to-point interconnection between all cells. The curves are based on an analysis of the following: in the 100% redundancy case the end users of all cells need to fetch 10 Gbps of content from the Internet; in the HRP case, cell A users will get 25% of the requested content through A, 25% through B, etc. which means each peering link is loaded with 2.5 Gbps per direction, which means 30 Gbps aggregate. Since we have 100% redundancy, the 2.5 Gbps of content crossing A's transit link in response of requests from end users of cells A, B, C and D are the same and only need to be fetched once and then cached in network A. Then we consider cases with 75%, 50%, 25%, down to 0% redundancy. To keep the model simple, X % redundancy means that X % of the content objects requested by network A, B, C and D will be in common across the 4 domains, while the other X % are unique items.

From the graph, it appears that HRP may be beneficial when any or both of the following are true: (i) the cost of peering links should be much lower than the cost of transit; and (ii) there is enough redundancy between content requested by peer networks.

In an extreme case where peering links are very inexpensive (e.g. between virtual node instances on the same physical node), HRP may be justified even with low redundancy rate. From the operator point of view, gains may be expressed by reducing the capacity of the backhaul/transit link, by enabling a larger end user base, and/or by providing more download capacity to existing end users. And when adding more peers in a full mesh configuration, additional gain on the aggregate backhaul may be had, at the expense of a greater usage of peer links.

Locality Sensitive Hashing

Hashing the content descriptor in its entirety may result in content requests towards a particular application or web site passing through different peer networks, and thus different backhaul. This may cause some issues, including, for example, a difference of perceived performance between different content object retrieved from the same service. For avoidance of at least some of the issues, in some embodiments, the HRP hash function applied on content descriptor may be chosen to be “locality sensitive”. Locality-sensitive hashing (LSH) is a class of hashing function having the property that similar input will result in similar or identical hash values. One example of such hashing function is a Nilsimsa Hash.

In some embodiments, the input of the HRP hash function may be selected to satisfy a desire to get all content requests targeting one domain through the same network peer. One way to do this is to only use the domain name as input, or more generally, a prefix (e.g., retrieving /example.com/video/avatar would lead to hashing /example.com).

In some instances, most or all requests towards a single, very popular domain like youtube.com may pass through the same HRP network peer. This may affect load balancing. To avoid this, the HRP routing protocol may limit that the network peer responsible for youtube.com to a small key range. In some embodiments, special hashing rules may be applied for certain (configured) popular domains. For example, for such domains, the whole content descriptor may be used as input to the hash function, ensuring that requests to youtube.com, in our example, are spread over all network peers.

Origin Server Located in One of the Peer Networks

HRP may coexist with local routing. When an origin server is located in one of the network peers, all content requests may pass through peering links, without interference with HRP, which deals with routes to content off the Internet. This can be done by having both HRP routes and regular routes exchanged between HRP routers.

In an example where CCN is used, a specific route to /local.org/path/to/content/ may be distributed over the peering links. This route may be more specific that HRP routes, which are default routes to /, resulting in this route being selected for all content requests with this specific prefix.

Rationale for HRP Routing Protocol

The HRP routing protocol may be used in lieu of configuring every network with static routing tables. The HRP routing protocol may adapt allocation and routing information for changing network conditions, such as, peering link and/or transit link failure.

The HRP routing protocol may handle complex peering network configurations, such as in the case of a large number of interconnected small cells, which interconnection may include a mix of hubs and loose mesh connections. The HRP routing protocol may handle changes in peering network configurations, such as, for example new connections and new small cells are added to an existing peering network.

The HRP routing protocol's dynamic nature may be adapted to handle operator policy considerations, such as, for example in the case where peering networks are ISP's networks, and operator policy considerations evolve over time, for example for business reasons, it may be too complex to require several ISPs to synchronize their changes: but one ISP can modify the configuration of its HRP router(s) to stop peering with one particular peer.

Exterior and/or Interior HRP Routing

HRP routing may enable different network peers to agree on how to distribute the hash value space between them. Interior HRP routing may propagate the HRP routing information inside a given peer network. Interior HRP routing may cause selection among multiple border routers to ensure that content requests will reach the appropriate border router. Network peers that have a single CCN router, HTTP Proxy, border gateway protocol (BGP) border router or open shortest path first (OSPF)/IS-IS border router, through which all content requests from all end users of this network are routed, do not require propagation of the HRP routing information. This central router may obtain HRP routing information from other peers using the exterior HRP routing protocol, and may make the routing decision on all content requests.

Distributed and/or Centralized Routing Protocol

A new distributed external HRP routing protocol is provided to enable networks peers to communicate with each other and allocate the key ranges. A distributed interior HRP may be used inside any given peer network to ensure that content requests are forwarded towards the appropriate border HRP router. HRP routing can be enabled through extension of an existing routing protocol, such as BGP (external and/or internal BGP), or interior routing protocols like OSPF, RIP, IS-IS, etc. Adaptation of existing routing protocols to HRP may include to replacing IP subnets with key ranges. Enhanced exterior routing protocols (e.g., BGP) may be well suited for use cases such as internet service provider (ISP) HRP federations, and enhanced interior routing protocols (e.g., OSPF) may be well suited for small cells federations.

HRP in the context of small cell networks may be enabled through a centralized means, such as an HRP software-defined networking (SDN) application running on an SDN controller. It may offer an API to HRP peers. The HRP peers may, for example, use the API to input some information about individual cell or network (e.g. backhaul capacity, caching storage capacity, load). The SDN application may then proceed with configuring SDN routers/switches to properly forward content requests.

Distributed Exterior HRP Routing Protocol

All HRP routers may agree on a hash function and hash-value space (e.g. the range [0 . . . 2̂32[). To simplify computations, the HRP routers may agree on a given granularity of the key range, such as 1/n^{th} with n=32 or 128 for example, of the hash value space. This granularity may be negotiated by the HRP routers during the initial connection setup, and may be influenced by router configuration. This way, the key ranges may be uniquely named by their index within [0 . . . n[.

One way to implement HRP in a distributed routing context may be to have each HRP router take responsibility for (or “allocate to itself”) one or more key ranges at a time, advertise them, and back off in case of conflict with another HRP router (i.e. de-allocate, wait a random amount of time, re-allocate later). All of the routers may do this, until, for example, the full range is allocated or the HRP routers decide that they are at full capacity and should not take any more key ranges. When a new HRP router is interconnected, it can attempt to “steal” certain key ranges from other HRP routers. The re-allocation may result in reach a new equilibrium (i.e., allocate, advertise and wait until the current holder de-allocates). The allocation message may include, for example, the requested key range, and an identifier or locator of a next hop (which can be, implicitly, the router initiating the allocation message). The allocation message, in some embodiments, may include cost information associated with the requested key range.

The HRP router may listen to advertisements from its neighbors, and may fill its HRP routing table with the advertisements. ‘N’ currently unallocated keyranges may be allocated by the HRP router. ‘N’ may be one or more, and/or may vary depending on conditions (e.g., ‘N’ may be large if a lot of unallocated key ranges exist and if the HRP router is far from full capacity).

The HRP router may also decide to allocate key ranges that are already allocated (e.g. by a distant router or by a preexisting, now overloaded router). One way to reduce a risk of conflict during allocation is to have the HRP routers obtain an ID within the hash value space (configured or a hash value of a MAC address, for example), and then use this ID as an anchor when making allocation decisions (e.g. allocating key range containing the ID first). Further allocations may be contiguous with existing allocations, increasing the key range index (for example).

The HRP router may determine it should stop allocating new key ranges if, for example, congestion is detected at the backhaul. For example, if congestion is above a threshold, the HRP router may stop allocating new key ranges. In some embodiments, if congestion is too high, the HRP router may start de-allocating some of its allocated key ranges.

The HRP router may determine it should stop allocating new key ranges if, for example, congestion is detected on one or more peer links (e.g., a particular peer link is determined to be saturated). In some embodiments, the HRP router may reduce allocation that results in traffic over the congested links.

The HRP router may determine it should stop allocating new key ranges if, for example, conditions of a Service Level Agreement (SLA) have been satisfied, e.g., peer A operator agreed to share a given fraction of its backhaul capacity, and determined through measurement that this value has been reached with the current key range allocation. HRP routers may advertise different allocations to different peers, especially for the purpose of limiting congestion over certain links, or enforcing a Service Level Agreement between the operators of the peer networks.

The HRP router may detect and/or may react to an allocation conflict in various ways. For example, when an HRP router allocates a new key range to itself, it may listen to the advertisements from the network peers before and after this allocation. If the same key range becomes allocated by another HRP router, an initial allocation conflict is raised. The initial allocation conflict may be handled by having both network peers de-allocate the key range, wait for a random back off time, and then re-try to allocate the same or a different key range. Alternatively, the HRP router with the lowest routing ID may de-allocate the conflicting key range, and the other HRP router maintains the allocation.

A second class of conflict may occur when a first HRP has a long standing allocation of a key range, and detects or is informed that a second HRP router may be attempting to “steal” such key range. The first HRP router may determine if it agrees with the second HRP router attempt of procuring the key range. For example, if the procurement by the second HRP router results in a more balanced allocation (e.g., the second router may be newly introduced in the network and has only a few key ranges), then the first HRP may relinquish the key range and may remove it from its advertisements. If the first HRP disagrees, it may maintain the key range. In some embodiments, both routers may advertise the same key range (e.g., they are distant in term of hops from each other, and may offer an alternative to their close neighbors).

The HRP router may determine where to forward content requests based on the HRP routing table. For example, the HRP router may decide to send content requests related to a particular key range through a particular peer network. If multiple entries in the HRP routing table include the same or overlapping key ranges, then the HRP router may choose (i) the closest network peer; (ii) a network peer that, based on policy or peer link usage, is preferred over other network peers. In some embodiments, the HRP router may take into account an in the HRP routing table entries that point to a network peer that is too far (e.g. too much lag), or may lead to an unacceptable peer link usage when determining where to forward content requests. In some embodiments, the HRP router may evaluate all entries, and then select one entry to effectively use for any given key range. This selection may be sticky it that it may be as long term as practical, to optimize the cache hit ratio in the cache of the responsible peer for key range.

The HRP router may reply with negative acknowledgements to requests for a key range it is not responsible for (unless, for example, it is on the path to the responsible peer and the HRP router is willing to route the request). The HRP router may reply with negative acknowledgements, for example, when the HRP router stops advertising a certain key range. This way other HRP routers may be made aware of the change (e.g., even if the allocation change was not yet distributed by the HRP protocol).

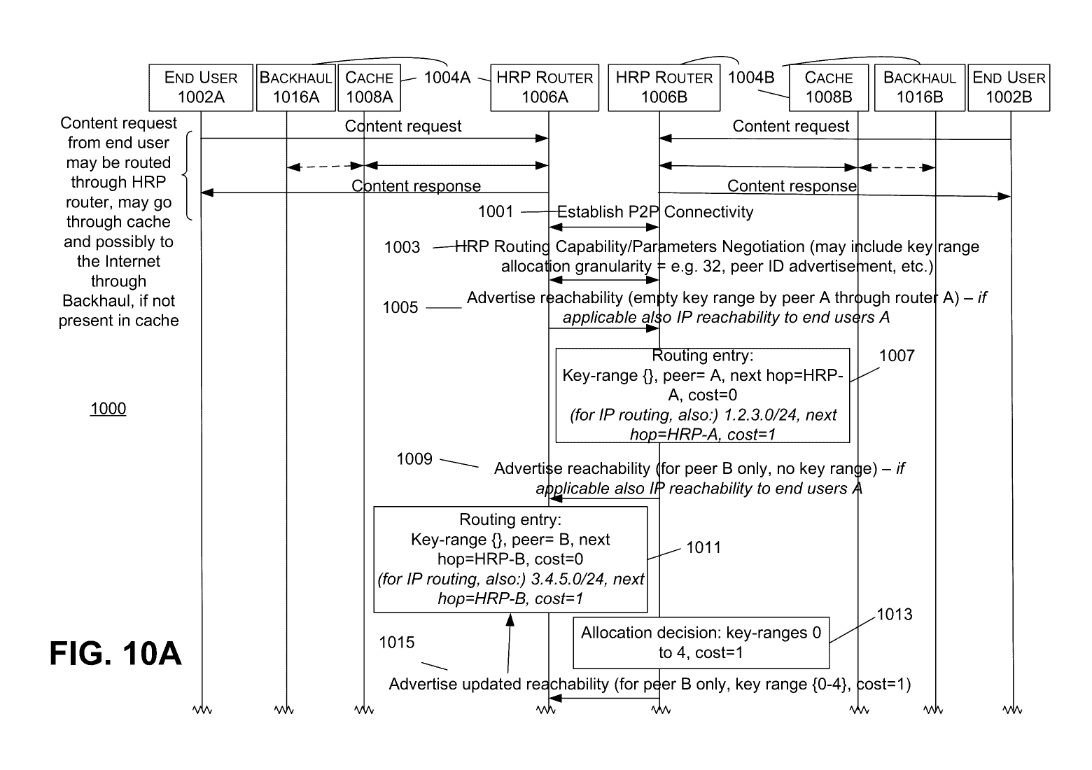

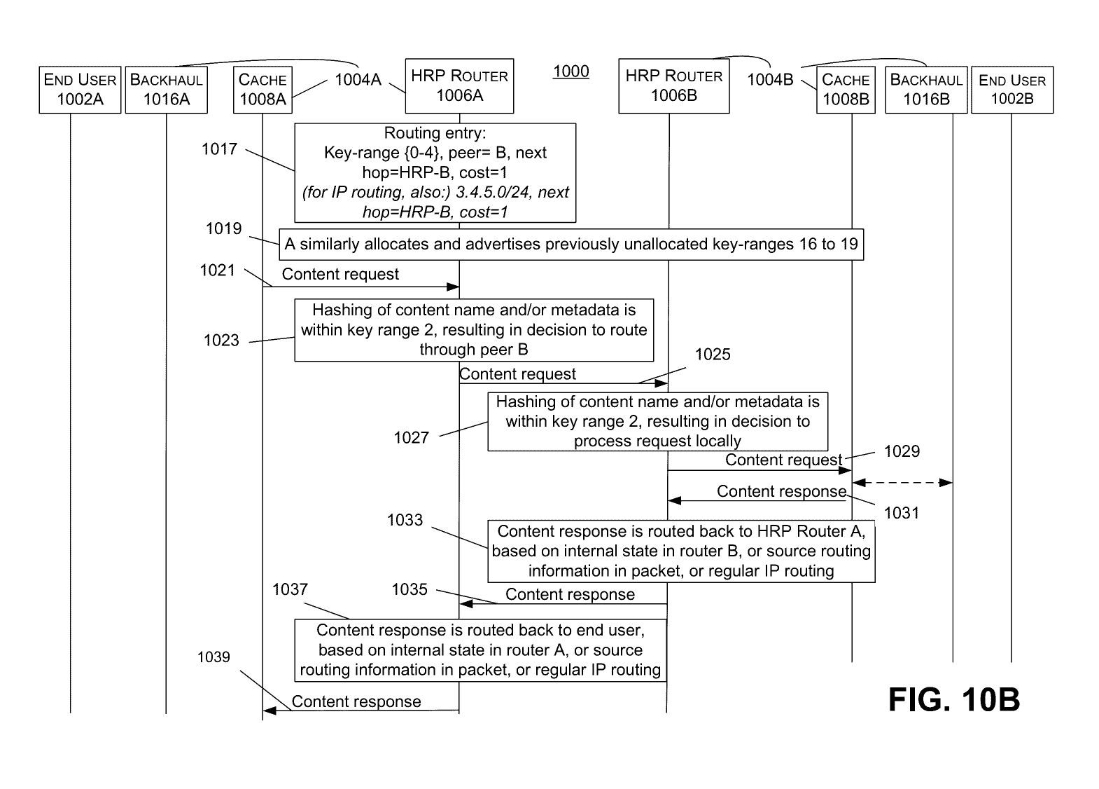

FIG. 10 is a message flow diagram illustrating an example HRP routing message flow 1000. HRP routers 1006_{A} and 1006_{B} of network peers 1004_{A} and 1004_{B}, respectively, may establish peer-to-peer connectivity (1001). The peer-to-peer connectivity may be established via an underlying transport network (not shown). After connectivity is established, the HRP routers 1004_{A-B} may negotiate HRP routing capabilities and/or parameters (1003). The capabilities and/or parameters may include, for example, key range allocation granularity, network-peer ID advertisement, etc.

The HRP router 1006_{A} may advertise or otherwise send reachability information associated with the network peer 1004_{A} to the HRP router 1006_{B} (1005). This reachability information may include key-range-reachability information and/or IP reachability information. The key-range-reachability information may indicate that no key range is allocated to, and/or reachable through, the network peer 1004_{A}. An empty key range included in the key-range-reachability information may be interpreted, for example, as an indication that no key range is allocated to, and/or reachable through, the network peer 1004_{A}. The IP reachability information may include IP routing information to end user 1002_{A}.

The HRP router 1006_{B} may listen for, and receive, the reachability information associated with the network peer 1004_{A} (1005). The HRP router 1006_{B} may populate such reachability information into a corresponding routing entry in its HRP routing table (1007).

Like the HRP router 1006_{A}, the HRP router 1006_{B} may advertise or otherwise send reachability information associated with the network peer 1004_{B} to HRP router 1006_{A} (1009). This reachability information may include key-range-reachability information and/or IP reachability information associated with the network peer 1004_{B}. The key-range-reachability information may indicate that no key range is allocated to, and/or reachable through, the network peer 1004_{B}. The key-range-reachability information may include, for example, an empty key range as, an indication that no key range is allocated to, and/or reachable through, the network peer 1004_{B}. The IP reachability information may include IP routing information to end user 1002_{B}.

The HRP router 1006_{A} may listen for, and receive, the reachability information associated with the network peer 1004_{B} (1009). Thereafter, the HRP router 1006_{A} may populate the reachability information associated with the network peer 1004_{B} into a corresponding routing entry in its HRP routing table (1011).

Based on the reachability information associated with both of the network peers 1004_{A-B}, the HRP router 1006_{B} may determine the entire hash-value space is unallocated. The HRP router 1006_{B} may select a candidate key range (e.g., key-range blocks 0-4) from the unallocated hash-value space, and may allocate the candidate key range to the network peer 1004_{B} (1013). Selection of the candidate key range may be based on any of backhaul, caching and/or other network resources of the network peer 1004_{B} and/or the network peer 1004_{A}; traffic conditions associated with the network peer 1004_{B} and/or the network peer 1004_{A}; capacity of one or more peer-to-peer links between the network peers 1004_{A-B}; and costs and/or like-type parameters associated with one or both of the network peers 1004_{A-B}.

The allocation of the candidate key range to the network peer 1004_{B} may be carried out using a procedure (“allocation procedure”) based on, modeled after and/or in accordance with publish-subscribe or like-type messaging patterns, where the HRP router 1006_{B} is the publisher and the HRP router 1006_{A} is the subscriber. Alternatively, the allocation procedure may be based on, modeled after and/or in accordance with contention and/or collision avoidance protocols.

An example of the allocation procedure is as follows. The HRP router 1006_{B} may presume that, once selected, the candidate key range is allocated to the network peer 1004_{B}. This presumption may be made without regard to the candidate key range being selected from allocated hash-value space or from unallocated hash value space (as in the example shown). If the candidate key range is selected from allocated hash-value space, then a possibility exists that, ultimately, the key range might not be allocated to the network peer 1004_{B}.

The HRP router 1006_{B} may update the previously advertised key-range-reachability information associated with the network peer 1004_{B} to reflect and/or facilitate dissemination of the allocation of the candidate key range. One way to update the previously advertised key-range-reachability information is to insert the allocated key range into such key-range-reachability information. Another way is to insert a reference to, or other alias for, the allocated key range in the previously advertised key-range-reachability information. The HRP router 1006_{B}, for example, may insert a routing table index associated with the allocated key range into the previously advertised key-range-reachability information associated with the network peer 1004_{B},

The HRP router 1006_{B} may advertise or otherwise send the updated key-range-reachability information associated with the network peer 1004_{B} to the HRP router 1006_{A} (1015). Alternatively, the updated key-range-reachability information may be sent along with other updates to the previously advertised reachability information associated with the network peer 1004_{B}, such as, updates, changes, revisions, etc. to cost information and/or IP reachability information.

The HRP router 1006_{A} may listen for, and receive, the updated reachability information or the updated key-range-reachability information associated with the network peer 1004_{B} (1015). The HRP router 1006_{A}, thereafter, may update the routing entry associated with the network peer 1004_{B} to include the allocated key range (1017). The HRP router 1006_{A} may also update the routing entry to reflect other updates, if any, carried by the updated reachability information and/or updated key-range-reachability information associated with the network peer 1004_{B} (1017).

Although not shown, the HRP router 1006_{B} may continue to presume the allocated key range is allocated to the network peer 1004_{B}. No explicit information may be sent to, and/or received by, the HRP router 1006_{B} to confirm the presumed allocation of the key range. Absence of an un-resolvable conflict in allocation of the key range may be an implicit confirmation of the presumed allocation of key range.

Similar to the HRP router 1006_{B}, the HRP router 1006_{A} may select a candidate key range (e.g., key-range blocks 16-19) from the unallocated hash-value space, and may allocate the candidate key range to the network peer 1004_{B} (1019). Selection of the candidate key range may be based on any of backhaul, caching and/or other network resources of the network peer 1004_{A} and/or the network peer 1004_{B}; traffic conditions associated with the network peer 1004_{A} and/or the network peer 1004_{B}; capacity of one or more peer-to-peer links between the network peers 1004_{A-B}; and costs and/or like-type parameters associated with one or both of the network peers 1004_{A-B}.

Like above, the allocation of the candidate key range to the network peer 1004_{A} may be carried out using any of various allocation procedures. In some embodiments, the allocation procedure may be based on, modeled after and/or in accordance with publish-subscribe or like-type messaging patterns, where the HRP router 1006_{A} is the publisher and the HRP router 1006_{B} is the subscriber. In some embodiments, the allocation procedure may be based on, modeled after and/or in accordance with contention and/or collision avoidance protocols. In some embodiments, the example allocation procedure described supra in connection with allocation of a candidate key range to the other network peer 1004_{A}. For the sake of brevity, such allocation procedure (modified as appropriate for allocation to the network peer 1004_{A}) is not repeated here.

After key ranges are allocated, the HRP router 1006_{A} may receive a content request from end user 1002_{A} (1021). The content request may include a content-object name and/or content-object metadata. The HRP router 1006_{A} may hash the content-object name and/or content-object metadata to obtain a corresponding hash value, determine that the hash value falls within the key range allocated to the network peer 1004_{B}, and based on such determination, decide to route the content request through the network peer 1004_{B} (1023). The HRP router 1006_{A} may forward the content request through the network peer 1004_{B} to the HRP router 1006_{B} (1025).

The HRP router 1006_{B} may receive the forwarded content request (1025) and hash the content-object name and/or content-object metadata to obtain the corresponding hash value, determine that the hash value falls within the key range allocated to the network peer 1004_{B}, and based on such determination, decide to process the content request locally (e.g., using its backhaul and/or caching resources) (1027). The HRP router 1006_{B}, for example, may forward the content request to the cache 1008_{B} or to a content source via the transit resources HRP router 1016_{B} (1029). The cache 1008_{B} or the content source may retrieve the requested content object, and respond to the forwarded content request with a content response that includes the retrieved content object (1031).

The HRP router 1006_{B} may receive the content response (1031), and may route the content response to the HRP router 1006_{A} (1033). Routing of the content response to the HRP router 1006_{A} may be based on any of an internal state of the HRP router 1006_{B}, source routing information in packets, standard IP routing, and like-type routing. Once routed, the HRP router 1006_{B} may forward the content response towards the HRP router 1006_{A} (1035).

The HRP router 1006_{A} may receive the content response (1037), and may route the content response to the end user 1002_{A} (1039). Routing of the content response to the end under 1002_{A} may be based on any of an internal state of the HRP router 1006_{A}, source routing information in packets, standard IP routing, and like-type routing. Once routed, the HRP router 1006_{A} may forward the content response towards the end user 1002_{A} (1035).

In some embodiments, non-HRP routing information, such as IP routing information may be exchanged to enable forwarding of the content response. In some embodiments, one or both of the HRP routers 1006_{A} and 1006_{B} may maintain state information to enable routing of the content response through an appropriate return path. The state information may be maintained, for example, in a pending interest table (PIT) or other like-type data structure.

In the example shown, only two key ranges are allocated—one to each of the network peers 1004_{A-B}. More key ranges may be allocated to one or both of the network peers 1004_{A-B} at any time after or in conjunction with the allocation of the two key ranges.

One or both of the HRP routers 1006_{A} and 1006_{B} may repeat the allocation procedure based on various capacities, thresholds, conditions and/or policies. The allocation procedure may be repeated by one or both of the HRP routers 1006_{A} and 1006_{B}, for example, (i) until the entire hash-value space is allocated, (ii) until some measure (e.g., an amount satisfying a threshold) of congestion occurs on a peering or transit link, (iii) until a specified percentage or portion of hash value space is allocated, (iv) up to a specified percentage or portion of caching resources are consumed or unavailable, (v) up to a specified percentage or portion of backhaul resources are consumed or unavailable, and/or (vi) a specified limit or policy limiting additional allocations. Alternatively, the allocation procedure may be repeated by one or both of the HRP routers 1006_{A} and 1006_{B} incrementally (e.g., in increments of time and/or size of key range) or at a controlled growth rate. As an example, before allocating more key ranges, the HRP routers 1006_{A} and 1006_{B} may wait until they determine that, in steady state, the HRP peering does not or is not likely to cause unacceptable congestion. Alternatively, the HRP routers 1006_{A} and 1006_{B} may allocate key ranges in various sizes as needed to limit unacceptable congestion on a peering or transit link.

Although not shown, in some embodiments, the hash value may be calculated once, and transported in the content request for use by upstream routers. Alternatively, the calculated hash value along with the content-object name and/or content-object metadata may be transported in the content request. This way, the federation can include routers of varying complexity—some may be capable of calculating the hash value and some might not be capable of doing so.

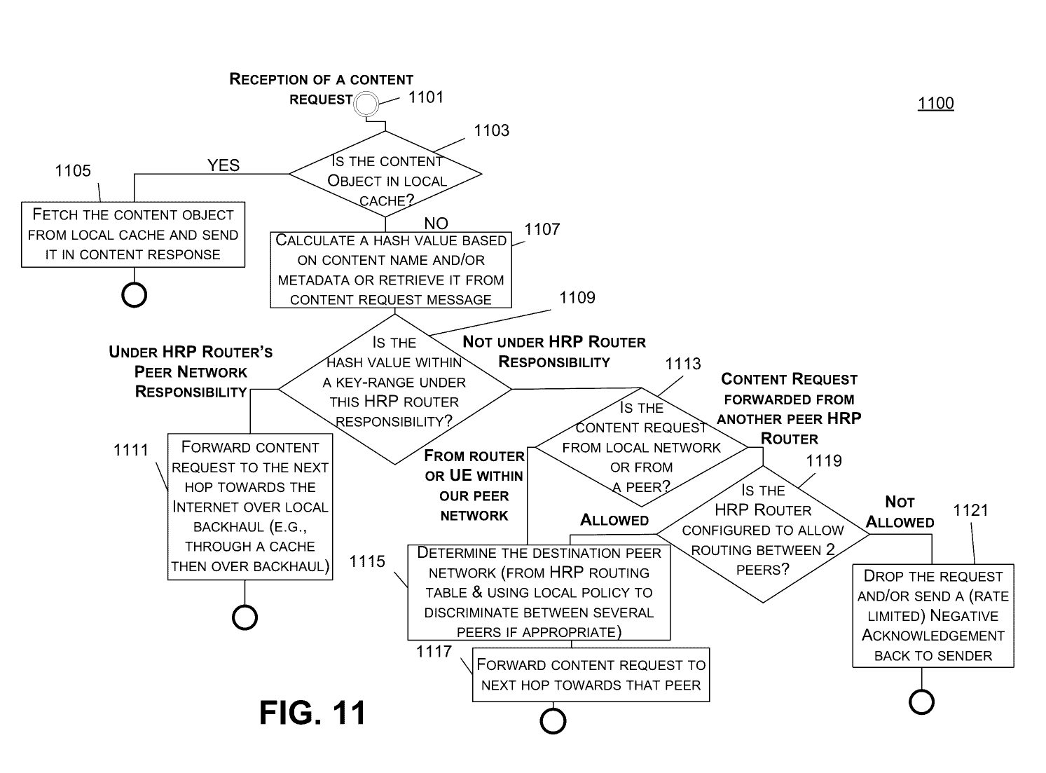

FIG. 11 is a flow diagram illustrating an example flow 1100 for making forwarding decisions in a HRP router, such as, a HRP border router, of a network peer. After receiving a content request for a content object (1101) from an end user or other entity of the network peer or from another network peer or (collectively “requestor”), the HRP router makes a determination of whether the content object is retrievable from a local cache (1103). If the HRP router determines the content object is retrievable from the local cache, the HRP router may fetch the content object from the local cache, and may send to the requestor a content response that includes the retrieved content object (1105).

If the HRP router determines the content object is not retrievable from the local cache, then the HRP router may obtain a hash value corresponding to the content object (1107). The HRP router may obtain the hash value by calculate it based on (e.g., hashing) a content name and/or metadata associated with the content object. Alternatively, the HRP router may retrieve the hash value from content request, if so included.

After obtaining the hash value, the HRP router makes a determination of whether the hash value is within a key-range under this HRP router responsibility (1109). If the HRP router determines the hash value is within a key-range under this HRP router responsibility (e.g., either a match found pointing to a local cache of the network peer, or no match found), then the HRP router may forward the content request to a next hop towards a content source over local backhaul (1111). The HRP router, for example, may forward the content request first through a local cache, and then over a backhaul.

If the HRP router determines the hash value is not within a key-range under this HRP router responsibility (e.g., a match found pointing to another network peer), then the HRP router makes a determination of whether the content request is from the local network or from another network peer (1113). If the content request is determined to be from the local network, then the HRP router may resolve or otherwise determine a target network peer to route the content request to (1115). The HRP router may reference its HRP routing table, and use one or more local policies to discriminate between several network peers, if appropriate, when determining the target network peer. After identifying the target network peer, the HRP router may route and/or forward the content request to a next hop towards such target network peer (1117).

If the content request is determined to be forwarded from another network peer, then the HRP router may determine whether the HRP router is allowed to route between the network peers (1119). If allowed, then the HRP router may resolve or otherwise determine a target network peer to route the content request to (1115). The HRP router may reference its HRP routing table, and use one or more local policies to discriminate between several network peers, if appropriate, when determining the target network peer. After identifying the target network peer, the HRP router may route and/or forward the content request to a next hop towards the target network peer (1117).

If the HRP router is not allowed to route between the network peers, then the HRP router may drop the content request (1121). The HRP router may send a (rate limited) NACK) back to the requestor.

Distributed Interior HRP Routing

The interior HRP routing protocol may not be used, for example, if a network peer has a single border router/gateway due to all nodes in the network only having to route content requests towards the single border router/gateway (which may be collocated with the ExteriorHRP routing function). The interior HRP routing protocol may not be used, for example, if a network peer has several egress points (e.g. one HRP router and one border router to backhaul/transit network) because all content requests may be routed through the HRP router, and the HRP router may forward content requests as appropriate, either towards the transit link, or towards a peer.

The interior HRP routing protocol may be used, for example, if a network peer has several egress points (e.g. one or more HRP routers and one border router to backhaul/transit network) route all traffic through one router might not feasible, practical and/or desirable. The interior HRP routing protocol may allow distribution of the routing information inside the network peer. In general, all HRP routers may advertise all key ranges they are interested in handling inside the network peer. To facilitate this, the HRP routers inside the network peer may be configured to be HRP aware, and/or may route content requests based on key range. The content requests mapping to a default route may be processed as if no HRP is used; they may pass through a cache and/or leave the network through a backhaul/transit link. Interior HRP routing may be implemented by extending OSPF/IS-IS/other routing protocol in a way similar that the exterior HRP routing may be implemented by extending OSPF/IS-IS/other routing protocol, possibly using the same encoding of key-range advertisement.

Centralized Exterior HRP Routing

Centralized Exterior HRP routing may, in some embodiments, be carried out using an SDN controlled exchange point. In the example where HRP network peers are small cells operated by the same entities or cooperating entities, several small cell peers may be interconnected with one exchange point network that includes one or more SDN routers/switches under an SDN controller. The HRP routing function may be implemented in the SDN controller, such as, for example, layered on top of a key range based routing control stack. Example details of a key range based routing control stack may be found in U.S. patent application Ser. No. 13/952,285 filed on 26 Jul. 2013 (Attorney Docket Ref. 11477US02) (“'285 application”), which is incorporated herein by reference.

Each network peer may provide feedback to the SDN controller. This feedback may include, for example, backhaul and peer links load and cache hit ratio. The feedback may be obtained by the SDN controller using various protocols, such as SNMP or NetConf. Alternatively, the SDN controller may implement a Northbound interface that the HRP routers may use to provide this same information. Based on this input, an SDN HRP routing application may estimate a (e.g., optimal) partition and/or other allocation of key range responsibilities between the small cell peers. The SDN HRP routing application may use key range based routing functionality, such as, for example, provided in the '285 application, to configure the exchange point switches/routers to forward content requests based on the hash value of the content name.

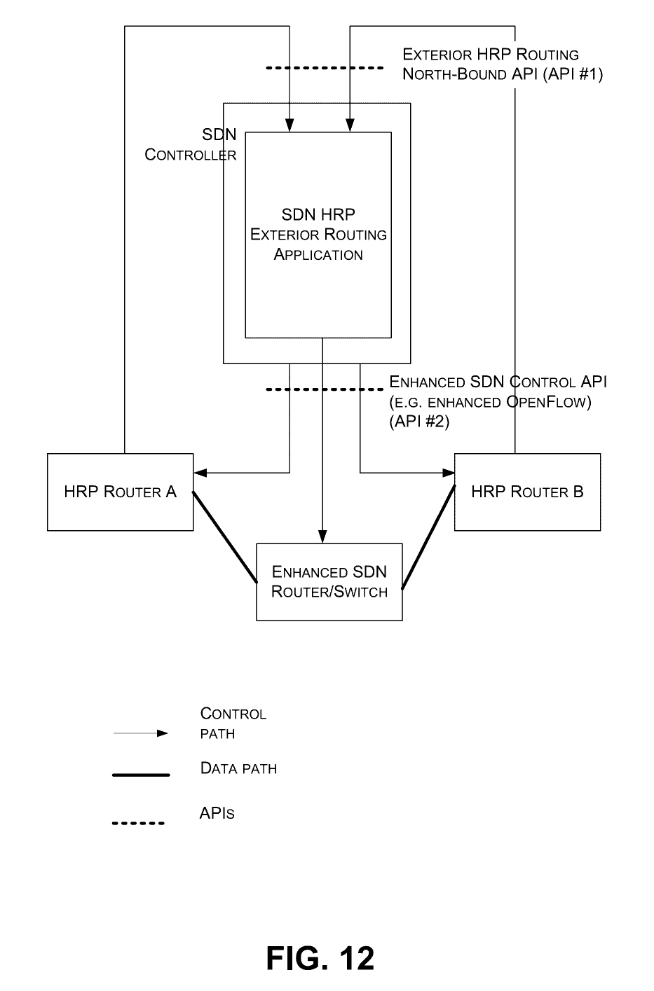

FIG. 12 is a block diagram illustrating example SDN stack and connectivity for centralized exterior HRP. The SDN stack is as follows:

The HRP routers A and B may provide input to, and obtain information from, the SDN HRP exterior routing application using API #1 (e.g. a JSON over HTTP API) offered by the SDN Controller. The API actions may include any of:

(i) POST/ehrp/peer-configuration, where the HRP router informs the application of its network peer configuration, including for example backhaul link capacity and caching capacity of the network peer;

(ii) POST/ehrp/peer-status, where the router updates its current load and other status information (current outage status, backhaul link load, cache load and hit ratio, load of any peer link); and

(iii) POST/ehrp/peer-connectivity, where the HRP router sets its willingness to route traffic to/from other interconnected peers, as well as the peer link capacity with these peers.

The SDN HRP exterior routing application may take this input into consideration to compute the key range allocation for each HRP network peer. The SDN HRP exterior routing application may determine, for each HRP network peer, and within such peer for each key range, which network peer will be responsible to fetch the content objects associated with this key range. As a result, for each HRP network peer and for each SDN router/switch forming the internetwork between them, the SDN application may associate a flow forwarding rule with any of the key ranges.

The SDN HRP exterior routing application may use a key range enhanced OpenFlow API, such as, for example, provided in the 'XXX application, to setup key range based forwarding rules in the enhanced SDN/Switches and HRP routers. The forwarding mechanisms of such devices may also be enhanced (such as, for example, provided in the 'XXX application) to match a certain field of the messages (i.e. a field in the content request) with a key range described in the flow table. Alternatively, the forwarding mechanisms may be enhanced to match a hash value calculated from a message field (e.g. the content name) with a key range entry described in the flow table.

Centralized Interior HRP Routing

Centralized Interior HRP routing may, in some embodiments, be carried out using an SDN controlled peer network. Border HRP routers may use a centralized or distributed exterior HRP routing protocol. Border HRP routers may provide their HRP routing table to an interior HRP routing application employed by the SDN controller. Based on this information, the SDN controller interior HRP routing application may use key range based routing functionality, such as, for example, provided in the 'XXX application, to configure the exchange point switches/routers to forward content requests based on the hash value of the content descriptor.

The centralized interior HRP routing and the centralized exterior HRP routing may differ as follows:

(i) input to the SDN Controller interior HRP routing application may be different. The input to the SDN controller interior HRP interior HRP routing application may be the HRP routing table. The input to the SDN controller exterior HRP routing application may be usage measurements.

(ii) computation of the interior HRP routing application and exterior HRP routing application may be different. For the exterior HRP routing application, the application may include logic for allocating key ranges. For the exterior HRP routing application, such allocation may already be present in the input. The interior HRP routing application may use an API, such as, for example, API #2 provided in the 'XXX application, to have content requests routed to the appropriate HRP border router.

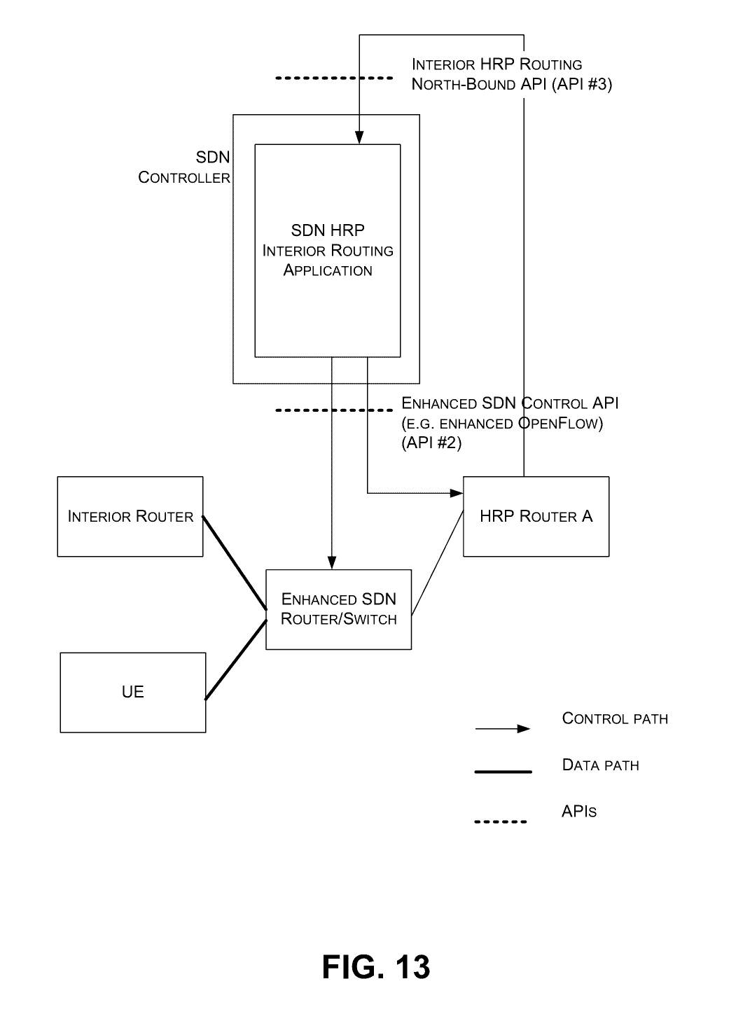

FIG. 13 is a block diagram illustrating example SDN stack and connectivity for centralized interior HRP. The SDN stack may be as follows:

The HRP Router A may provide input to the SDN HRP interior routing application using an API #3, (e.g., a JSON over HTTP API) offered by the SDN Controller. The API actions may include: (i) POST/ihrp/handled-key-ranges, where the router provides the application with the set of key ranges that it wishes to receive from routers and WTRUs inside its own domain. These key ranges may be the ones that this router need for forwarding towards HRP peers. Router A may obtain this list from its internal state (which may have been built using exterior HRP routing); and (ii) The SDN HRP interior routing application may determine, for each interior SDN router/switch, how to forward each key-range in order to have content requests reach router A.

The SDN HRP interior routing application may use a key range enhanced OpenFlow API #2 such as, for example, provided in the 'XXX application, to setup key range based forwarding rules in the enhanced SDN/Switches and the HRP routers. The default routing may to apply to content requests that do not match any explicitly handled key range. The default routing may route content requests through local caches and then over the backhaul link towards the Internet.

HRP System

An HRP system may include one or more of: (i) distributed or centralized exterior HRP routing; (ii) need or no need for an interior HRP routing protocol; (iii) ICN-based or HTTP-based content distribution; (iv) route-by-name ICN; (v) lookup-by-name ICN; and (vi) extensions of OSPF, IS-IS, BGP or other routing protocols.

Example HRP Between Small Cells in Route-by-Name ICN Networks

An HRP system may be implemented for a set of small cells operated by the same operator, or by operators closely cooperating together. A route-by-name ICN protocol; such as CCN, may be used to route content requests in all network peers. The system may include CCN routers enhanced with HRP (“HRP-enhanced CCN routers”). The HRP-enhanced CCN routers may be interconnected with each other using peer-to-peer connection. The HRP-enhanced CCN (e.g., interior and/or exterior) routers may have one or more of the following features:

(i) HRP-enhanced CCN routers may exchange a new type of routing message, CCN routing messages, for example the allocation message described supra. OSPF may be enhanced to support hash-value (key) range advertisement. This may be done using an OSPFN Opaque Link State Advertisement (LSA) in which the LSA Opaque information (body) may include HRP routing information, such as, for example, hash-value (key) range scheme, cost, etc.

(ii) a FIB may be enhanced to include HRP routing entries. The FIB may also be enhanced with forwarding logic that makes use of the new information elements in the HRP routing entries.

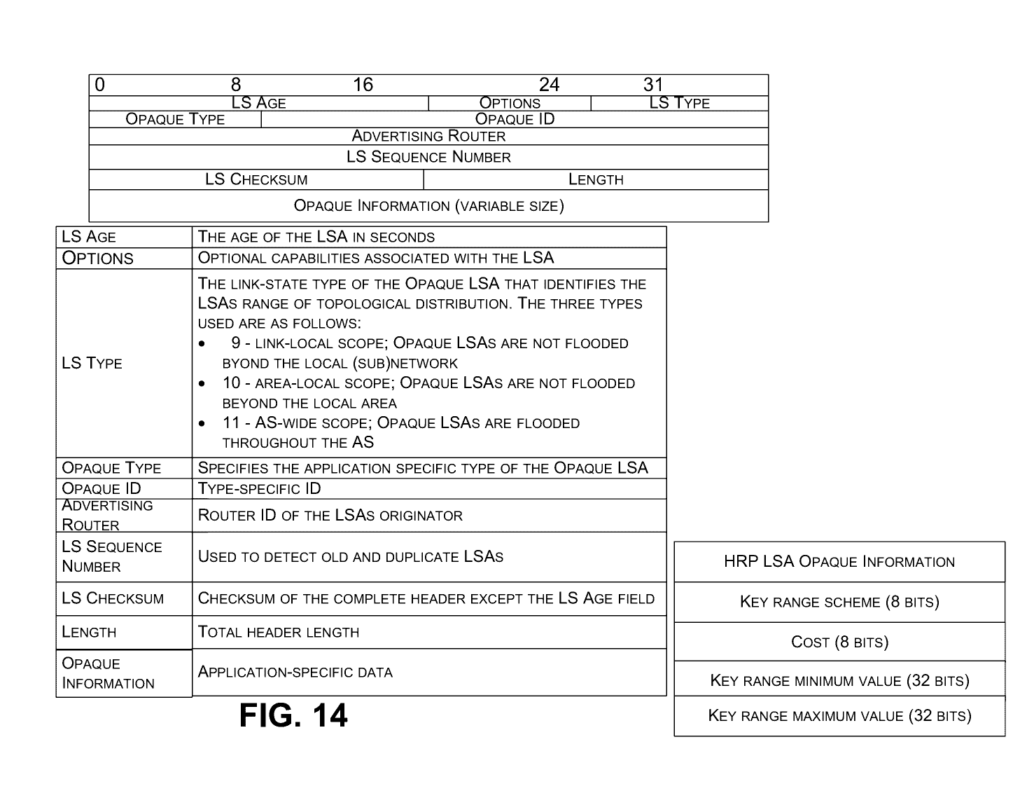

FIG. 14 is a block diagram illustrating an example message structure for OSPF Opaque LSA extension for HRP hash-value (key) range allocation advertisements. The Opaque Information may include CCN prefix advertisement to enable normal CCN routing and/or a new type of Opaque LSA to support HRP Routing (show in block including the HRP LSA Opaque Information).

The key range scheme may, for example, encode the choice of hash-value space (such as [0;2̂n[ with a well-known value for n) and/or the key range granularity (e.g. a well-known value p). One possible value may be, for example, DEFAULT_HRP_SCHEME=0, which may refer to n=32 and p=128.

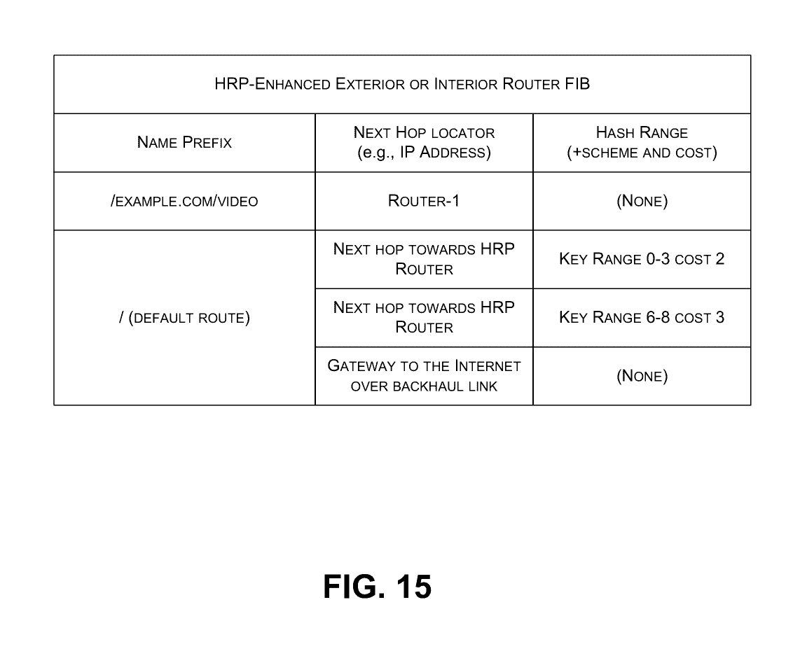

FIG. 15 illustrates an example CCN FIB enhanced to support HRP routing (“HRP-enhanced CCN FIB”). The HRP-enhanced CCN FIB may include entries that have several next hop locators associated with one name prefix. The HRP-enhanced CCN FIB may associate HRP hash-range information to a next hop.

Part of the forwarding procedure may include an HRP-enhanced CCN router first checking a requested content name against the FIB, and if several competing routes are available, then HRP-enhanced CCN router may use the hash range information to discriminate between them.

In some embodiments, the HRP routing table is maintained in a data structure handled by the strategy layer of the HRP-enhanced CCN router, and the CCN FIB might not be enhanced to support HRP routing. The strategy layer of the HRP-enhanced CCN router may check a requested content name against the data structure therein, and may perform the discrimination of competing routes. To facilitate this, the hash range information may be included in the FIB in a logical manner (e.g., the actual FIB is unchanged from its current form, and the strategy layer maintains the HRP routing table). Once the HRP-enhanced CCN router determines that the default route is selected, the HRP-enhanced CCN router may request a forwarding decision from the strategy layer. The HRP-enhanced strategy layer may calculate or otherwise obtain the hash value, and may check its HRP routing table to determine over which interface to forward the content request.

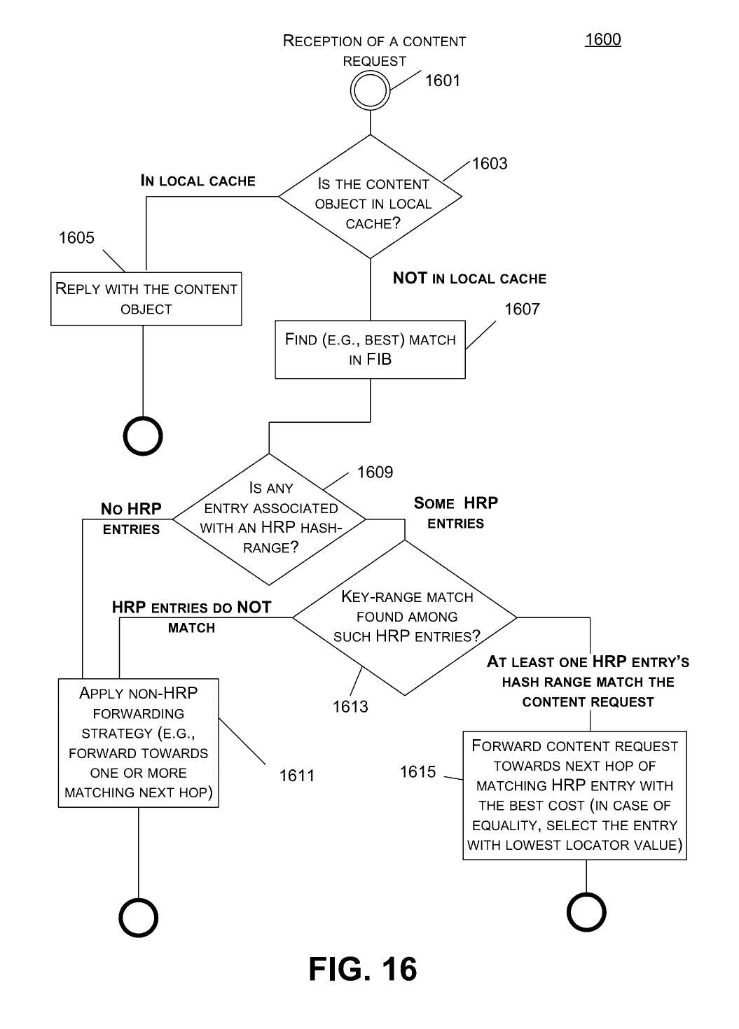

FIG. 16 is a flow diagram illustrating an example forwarding decision flow 1600. The forwarding decision flow 1600 may be carried out by a HRP-enhanced interior CCN router.

The HRP-enhanced interior CCN router may receive of a content request (1601). The HRP-enhanced interior CCN router may thereafter determine whether the content object is available from the local cache (1603). If content object is in the local cache, the HRP-enhanced interior CCN router may reply with the content object (1605). If the content object is not the local cache, HRP-enhanced interior CCN router may find (e.g., best) match in the FIB (1607).

The HRP-enhanced interior CCN router may determine whether the FIB includes any entry associated with an HRP hash-range (1609). If the FIB lacks such entry, then a non-HRP forwarding strategy may be applied (e.g., forward towards one or more matching next hop) (1611).

If the FIB includes one or more HRP entries associated with an HRP hash-range, then the HRP-enhanced interior CCN router may determine whether a key-range match is found among such HRP entries (1613). If no match is found, then the non-HRP forwarding strategy may be applied (1611). If at least one HRP entry's hash range matches the content request, then HRP-enhanced interior CCN router may forward the content request towards next hop of matching HRP entry with the best cost (in case of equality, the entry with lowest locator value may be selected) (1615).

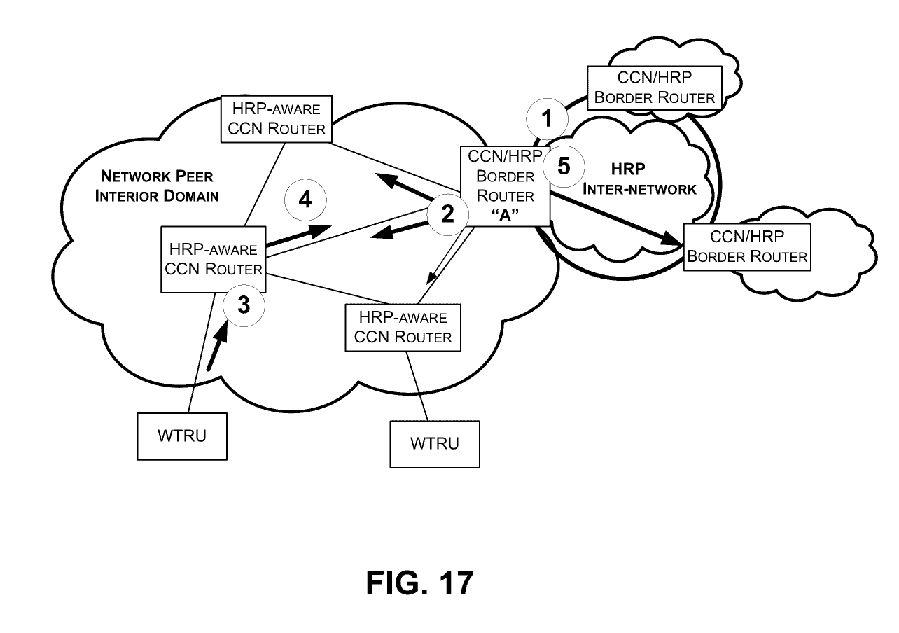

FIG. 17 illustrates a forwarding decision procedure 1700. The forwarding decision procedure 1700 may be carried out in a HRP-enhanced interior CCN router.

At 1, HRP border routers may exchange routing messages over enhanced OSPF. Each network peer may be a distinct OSPF routing area. The OSPF Opaque LSA extension for HRP key range allocation advertisements (“HRP-Opaque LSA extension”) may be used to hold advertisement information. The CCN/HRP border routers may use the exchanged information to build and maintain an HRP routing table.

At 2, HRP border router A may flood the HRP routing table inside its own network using the HRP-Opaque LSA extension. The HRP routing table may be simplified, e.g., all contiguous entries may be collapsed since all content requests may go through HRP border router A. All CCN routers may maintain the HRP table inside their HRP-enhanced strategy layer.

At 3-4, a WTRU may send an interest packet. The interest packet may reach one of the interior routers. The HRP-enhanced router may determine, using a descriptor-hash value corresponding to the content request and upon matching it in its enhanced FIB, that the content request may be routed towards HRP router A.

At 5: the HRP router A may look up the descriptor-hash value in its HRP routing table, and may forward the content request through the appropriate peer HRP router. That second peer may then retrieve the content object from a local cache or over a backhaul link. The content object may be sent back following a conventional CCN practice (e.g., over a return (reverse) of the path taken by the request, using state within the CCN routers to determine this return path).

In the procedure above, the descriptor-hash value might not be determined at every router. The descriptor-hash value may be calculated once (by the sender or by a CCN router), and inserted in the interest packet (e.g. as an additional field of the packet header, or alternatively as a component of the name: /example.com/video/avatar could become /example.com/video/avatar/hash=12345).

The foregoing HRP enhancements (e.g., enhancing the routing protocol and enhancing the forwarding procedure) might not be tied with the specifics of CCN design, and may apply to any other routing-by-name ICN design, such as in network of information (NetInf).

HRP Between ISPs in Route-by-Name ICN Networks

In some embodiments, several ISPs may be HRP peers. Inter-ISP communication may use BGP. BGP may be extended to support HRP. For simplicity of exposition, the ISPs may be assumed to be using CCN internally to route content requests and responses, e.g., as provided supra. A BGP extension may be formed by enhancing BGP to exchange HRP reachability information. A new Network Layer Reachability Information (NLRI) is provided. The NLRI may make it possible for BGP peers to advertise a certain key range associated with other information, such as, cost.

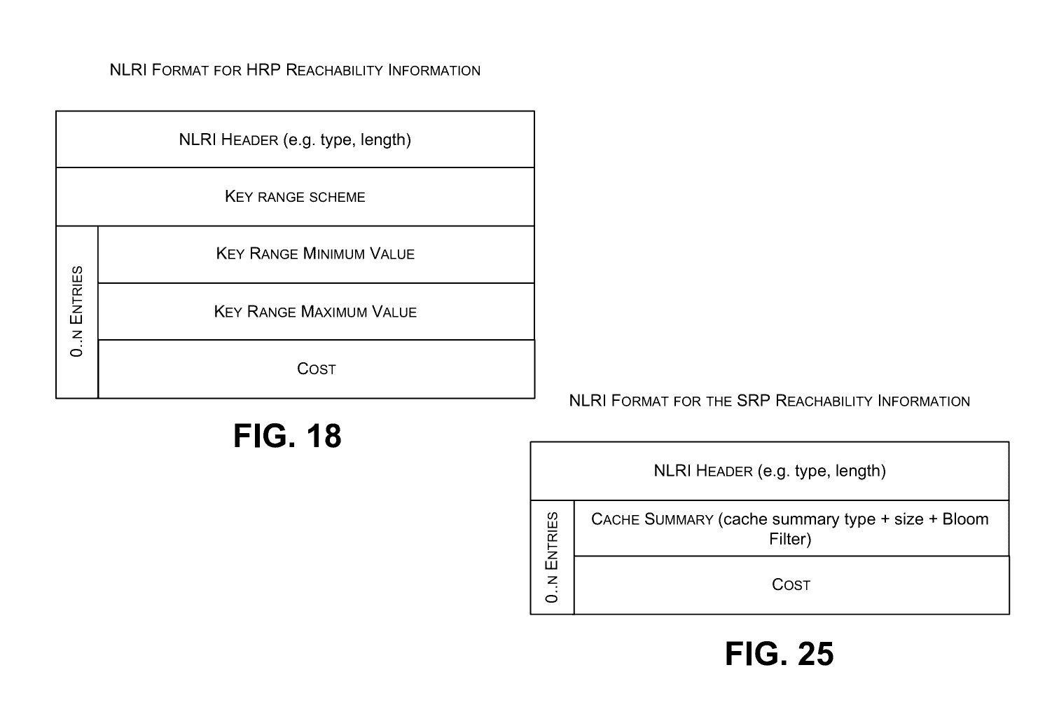

FIG. 18 illustrates a BGP NLRI format for HRP Reachability Information. HRP advertisements may be exchanged as provided supra. The BGP/HRP routers may maintain the HRP routing table and/or may distribute it internally in the ISP's network, such as, for example, provided supra. New fields (scheme, key range min/max values and cost) may have the same meaning as the OSPF extension's fields provided supra with respect to FIG. 14.

HRP Over HTTP Proxies in IP Networks

In some embodiments, the HRP routers may be HTTP caching proxies. An end user WTRU may be configured to use one or more of the HTTP caching proxies. Alternatively, the WTRU may automatically detect such HTTP caching proxies. The WTRU may, for example, use a Web Proxy Auto-Discovery (WPAD). The HTTP proxy that the WTRU connects to may calculate a descriptor-hash value using any input URL and/or of another characteristic of the request (e.g., the domain name, or a combination of the components of the URL). Such HTTP proxy may forward requests through peer caching proxies. These proxies may exchange routing information beforehand, as provided supra, so as to distribute the responsibility over the hash value space between several peer proxies.

In some embodiments, the HRP Router/HTTP caching proxy may communicate the HRP routing table information to the WTRU. This may let the WTRU distribute requests between the different caching proxies. Doing so, may incur less overhead due to only a single proxy being involved in any given content request. In some or all of these embodiments in which HRP is employed in both network and WTRU domains, the WTRU may have an enhanced FIB/routing table including HRP entries. The forwarding logic implemented by the WTRU may be similar to the forwarding logic provided supra with respect to the HRP router of FIG. 11, except that the WTRU typically does not forward any content request it receives from other nodes.

In some or all embodiments in which HRP is employed in the network domain and/or HRP is employed in both network and WTRU domains, signaling and procedures provided supra, e.g., with respect to one or more of the FIGS. 10-13, may be applicable. HRP routing messages may be implemented on top of HTTP, for example, using an XML or JSON encoding.

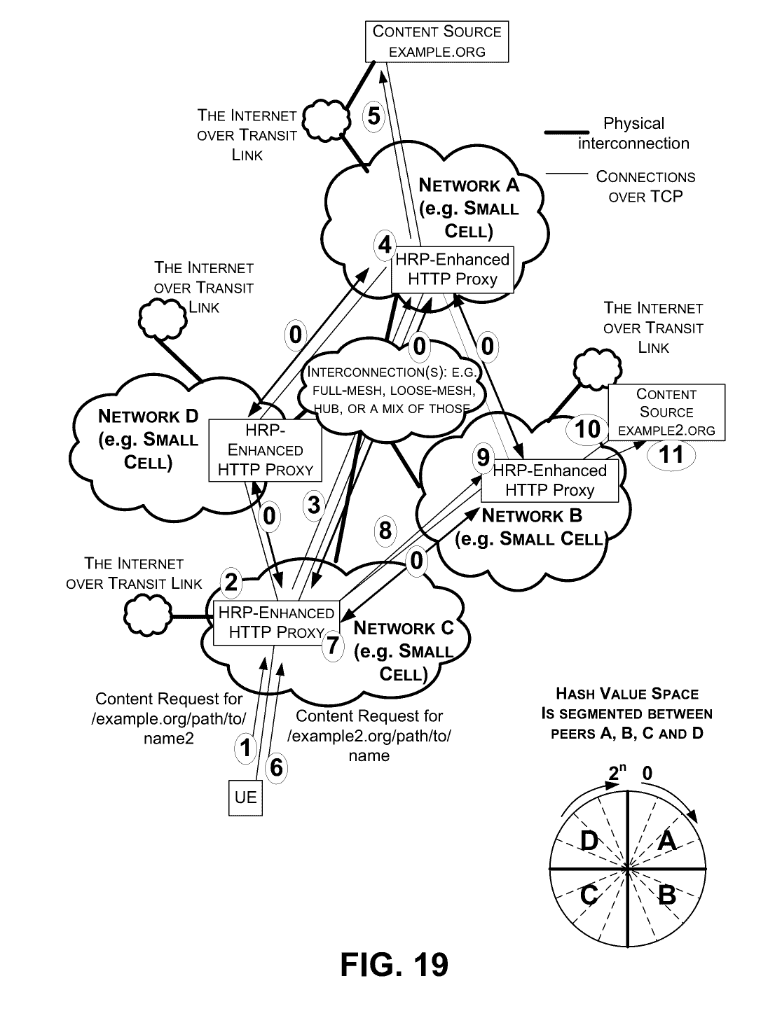

FIG. 19 is a block diagram illustrating an example of HRP over HTTP proxies in an IP network. In this example, a WTRU may use a single HRP-enhanced HTTP cache.

At 0, HRP-enhanced HTTP proxies 1906_{A-D} between peered networks 1904_{A-D} may exchange HRP routing advertisements. These HRP routing advertisements may be exchanged, e.g., as provided supra with respect to one or more of the FIGS. 10-13, and/or using JSON over HTTP messages as provided infra. The HTTP Proxies may initialize and maintain their respective HRP routing tables using information collected from the exchange HRP routing advertisements. Prior to exchanging advertisements, the HTTP Proxies may exchange other information, such as, configurations and/or capabilities. In the example shown, the peering network has a partial mesh topology in that is no peering link is established between networks 1904_{B} and 1904_{D}.

At 1, a WTRU may send a content request for a certain content object towards network 204_{C}. The request may be sent using HTTP GET, through its HTTP proxy C, for example. At 2, the HRP-enhanced HTTP Proxy C may look up in its HRP routing table a descriptor-hash value calculated from the request, and may determine that network 1904_{A} is responsible for the key range this content request falls in. At 3, the HTTP Proxy C may forward the content request message through HTTP Proxy A.

At 4: the HTTP Proxy A may verify that network 1904_{A} is responsible for the content object. The HTTP Proxy A may check whether the content object is in the local cache. After determining that content object is not available from the local cache, the HTTP Proxy A may fetch the content from the content source (e.g. DNS lookup followed by HTTP GET), as shown at 5. After receipt of a reply, the HTTP Proxy A may verify (by looking up again in HRP routing table, or by checking its internal state for the earlier check in 4) that network 1904_{A} is responsible for the content object. Based on a positive result, the HTTP Proxy A may enable locally caching the content object. The content object (in 200 OK response) may be sent back to HTTP Proxy C. The HTTP Proxy C may send it back to the original requester. Since network 1904_{C} is not responsible for the key range, the HRP-enabled HTTP proxy C might not cache the content object retrieved from the response. Alternatively, the HRP-enabled HTTP proxy C may cache the retrieved content object with a low priority.

The user plane behavior carried out in connection with reference numerals 6-11 is similar to the user plane behavior carried out at in connection with reference numerals 1-5, except for a different content object and such content may be found to be under the responsibility of network 1904_{B}.

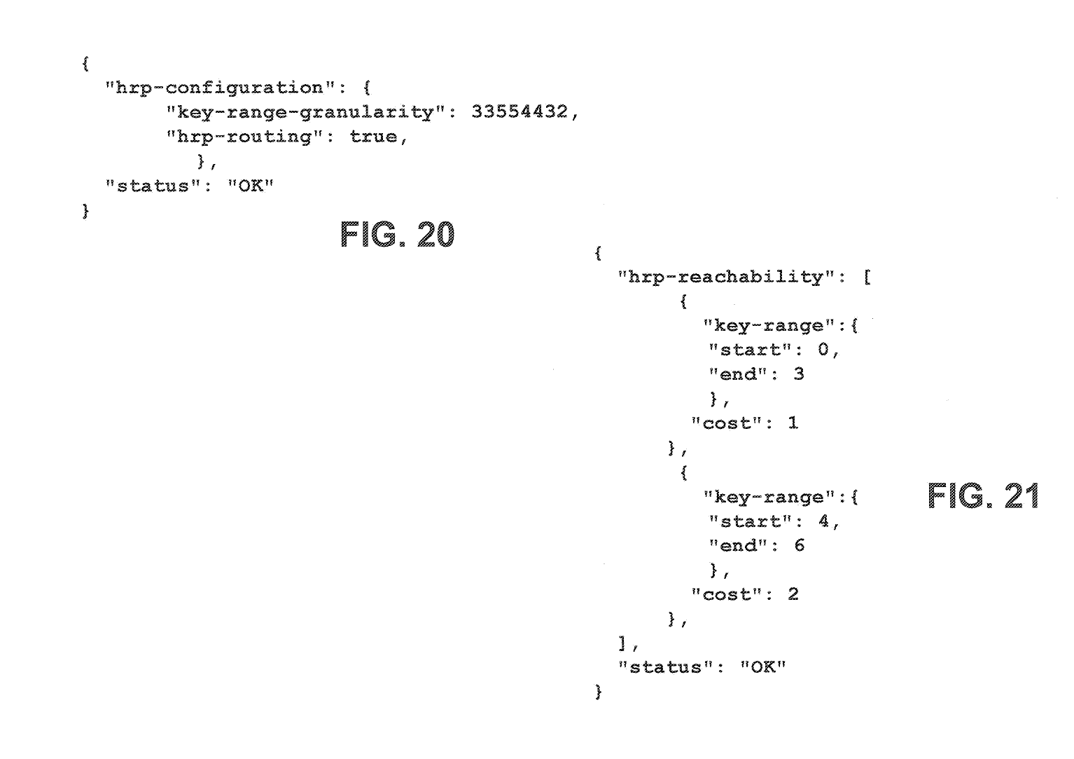

As discussed in supra in connection with reference number 0, before exchanging reachability information, peers may exchange HRP configuration. In the example shown in FIG. 20, key-range-granularity and hrp-routing are HRP specific configuration elements indicating respectively a unit for key range allocation, and whether the HRP router is willing to route traffic between different HRP routers. The key-range-granularity may be useful to keep routing tables easier to understand for human operators, and to prevent undue fragmentation of the routing table. Alternatively, the HRP may function without such granularity; additional procedures may be carried out to defragment the routing table.

FIG. 21 illustrates an example of HRP JSON Encoding for key-range reachability. In the example shown, the key range is expressed as a multiple of the granularity. The key range may be expressed in other ways, as well.

HRP in Lookup-by-Name ICN Networks

In the publish-subscribe internet routing paradigm (PSIRP) and other lookup-by-name ICN network designs, such as one variant of NetInf, requests for content may be enabled through 2 stages. In a lookup stage (first stage) a locator may obtained from a name resolution system (NRS). The locator may be obtained based on a content name present in the request. In a retrieval stage (second stage), the content may be retrieved using the locator.

One aspect of an ICN NRS system is that it has to be hierarchical, in order to be scalable. A local NRS may be an entry point of the lookup request. The local NRS may attempt to fulfill the request from locally available information, and if no such information is found, then the local NRS may forward the lookup request upstream. The HRP can be implemented in part in the local NRS. The HRP routers may communicate directly with each other (typically over IP), and may exchange HRP routing information, such as key range, identifier of next hop, cost, as described supra with respect to one or more of the FIGS. 10-13. Following this, each HRP router may communicate the HRP routing information to the local NRS of its own local domain.

When an end user of network peer A looks up a content descriptor through a local NRS A, the NRS A may use the HRP routing information to determine which local NRS is responsible for this content object. In some embodiments, network peer B may responsible for the key range that includes the hash value corresponding to the content object. The NRS A may redirect the end user to NRS B, and/or may forward the lookup request to NRS B. The NRS B may discover that this content object is in cache B and serve the request. Alternatively, the NRS B may decide to forward the request to the upstream NRS(s).

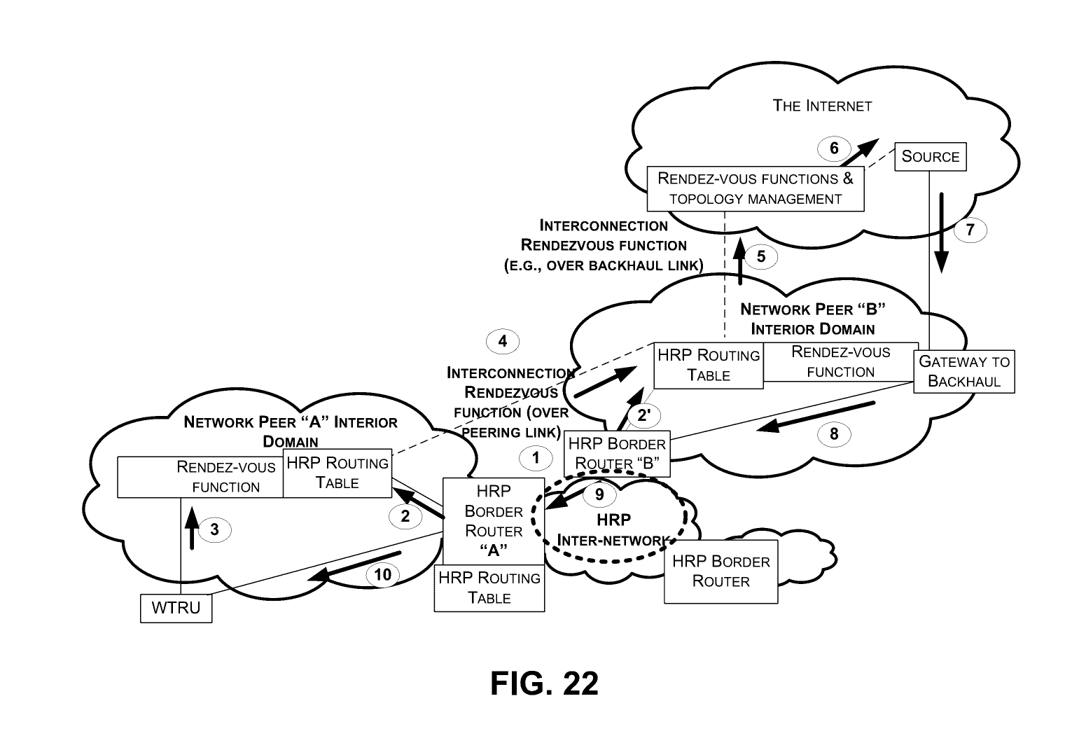

FIG. 22 is a block diagram illustrating and example of HRP Peering within a lookup-by-name based ICN system. The lookup-by-name based ICN system may be, for example, in accordance with PSIRP and/or a variant of NetInf.

At 1, the HRP border routers may exchange routing messages over enhanced OSPF (for example). Each network peer may be a distinct OSPF routing area. The HRP-Opaque LSA extension may be used to hold advertisement information. The HRP border routers may use the exchanged information to build and maintain an HRP routing table. The information exchange may replace the “next hop locator” information element with the “rendezvous function entry point locator”.

At 2 and 2′, the HRP border routers nay communicate the HRP routing table (and any update to it) to the local rendezvous function. The rendezvous function may refer to a name resolution system in accordance with PSIRP.

At 3, a WTRU may request a content object. The WTRU may send the request to the local rendezvous function. At 4, the rendezvous function may calculate the descriptor-hash value (or obtain it from the request). The rendezvous function may look up the descriptor-hash value in the HRP routing table. The table may point to the rendezvous function of network peer B. The rendezvous function A may forward the content request to the rendezvous function B.

At 5-6, after it verifies that it is responsible for the content request (e.g. by looking it up in its HRP routing table), the rendezvous function B may process the content requests using conventional PSIRP processing. Assuming that no local match is found, the rendezvous function B may forward the request upstream to a global rendezvous function, where a match is found. A topology manager may be requested to compute a path for the content request, and the resulting forwarding identifier is provided to the selected content source.

At 7-8-9-10, the content response may be sent back to the requester, using conventional PSIRP processing. Local topology managers may be involved to build local paths for the content response flow. The content may be cached locally in network peer B for future use, as well.

ISP HRP Federation, P2P Links

ISPs may enter into peering agreement with each other, under which they agree to directly exchange traffic over a peer-to-peer link, typically without any exchange of money, because it is mutually beneficial to exchange such traffic. In this type of peering, the traffic is from customers of one peer to customers of another peer.

In the HRP agreements, ISPs may agree to cooperate and share their caching capacity and their transit links, with the understanding that some of the content requested by customers of one ISP will be requested by customers of the other, and will result in overall reduced transit link load. The HRP routing protocol for ISP HRP federation using peer-to-peer links may be the enhanced BGP protocol provided supra.

ISP HRP Federation, Exchange Point

ISPs typically connect to each other at exchange points (IPX″). Such exchange points, or similar connection hubs can be used for HRP interconnection between several ISPs. In some embodiments. a central HRP routing entity may be collocated with the exchange point. This HRP routing entity can maintain central HRP routing/allocation and then communicate this information to each individual HRP peer ISP. In the context where BGP is used, this can be seen as enhanced BGP route reflector. A BGP route reflector may be used in the context of BGP federations, where a single autonomous system (AS″) is subdivided in multiple sub-AS, and a route reflector may be used to reduce the number of mesh connections by introducing a central point. HRP peering between (sub-)networks operated by a single operator could follow this model, using an enhanced BGP router reflector at an exchange point, while HRP peering between different entities can use enhanced BGP routing based on point-to-point connections between BGP routers.

Small Cell HRP Federation

Small cells may be isolated access network using a backhaul link to communicate with the rest of the Internet. With HRP, it is possible to interconnect these small cells to benefit from redundant interest from end users of different small cells. As provided supra, to maximize the effectiveness of HRP, the more peers the better, which peers may use peering links that are as large and inexpensive as possible.

Small Cell HRP Federation, Exchange Point

In one example deployment, several small cells may be connected with one exchange point, e.g. an Ethernet switch (e.g., small cells in a mall that may connect to this central switch using wired connections). The exchange point may include logic to route a particular request towards the responsible peer (RP).

Small Cell HRP Federation, Routing by End User's Nodes

In one example deployment, end users may directly attach with several cells simultaneously. The small cells controllers may advertise HRP routing information with each other. A WTRU may obtain the HRP routing table from the network (e.g. from one or more small cell controller), e.g. using a discovery protocol sending a multicast query and receiving a set of XML encoded HRP routing entries. The WTRU may then directly route content requests to the HRP router/small cell control responsible for it, based on a hash value.

Broadcast HRP Exchange Point

The interconnection point between network peers may be over a broadcast channel. Each network peer may be aware of the hash value space segment under its responsibility. A requesting small cell may not need to select the proper peering link, it may broadcast any content request it cannot fulfill itself and which is not under its own responsibility. All other small cells may listen on the broadcast channel and may check whether this content object name is under their responsibility. If it is, the responsible peer may handle the request, either from cache or using their backhaul.

Cellular Technology Implementation of Small Cells

In one exemplary implementation of a small cell with cellular technology the access node may be an eNodeB, which may be connected to a small cell gateway. This implementation may be enhanced to support HRP as follows. The eNodeB may be connected with the small cell gateway of all inter-connected peers (e.g., maintaining different bearers towards each peer). The HRP-enhanced eNodeB, upon reception of content requests from the end user (e.g. reception of ICN content request message or HTTP request), may determine which peer network is responsible for handling the requested content based on a descriptor hash value calculated by the eNodeB, and may forward the content request over the appropriate bearer towards the network peer small cell gateway.

Loose-Mesh Small Cell HRP Federation

It is not always possible or practical to have a full-mesh connection between small cells. Network operators can opportunistically deploy peer-to-peer links or local hubs between several peers in order to maximize the inter-connectivity between small cells, (e.g., within given cost and physical constraints). The HRP routing protocol can then be used to maximize the caching/backhaul gains leveraging these interconnections. After enhancement, network operators may identify problem areas and increase interconnectivity between small cells in these spots, and let the HRP protocol optimize usage of these new peering links.

To add coverage to a set of small cells, a full-blown small cell, which requires one more backhaul links, may be added. Alternatively, the coverage of a single small cell may be increased by adding more access nodes to it, which requires increasing capacity of the existing backhaul link or risk congestion of this backhaul. HRP may enable a third alternative, where a transit-less small cell is added, and is connected to an existing HRP federation of small cell peers, e.g. using peer-to-peer links or by connecting to many peers through a hub. A result of doing so is that the new small cell may use a fraction of the backhaul of several other small cells, which in turn, may dilute its impact on the backhaul congestion of the existing small cells.

Network sharing is a recent trend in cellular networking, which aims to greatly reduce costs. This may vary from simple site sharing to RAN sharing, and/or core network sharing. With the development of ICN, mobile network operators (MNOs) may deploy content caches in their core network, and small cells. HRP can be used between MNOs sharing the same small cells, or the same core network. The cost of operating peering links should be very low in this case, since caches from different MNOs would be collocated.

In some embodiments, repartition of objects between key ranges may result in unbalanced allocation. Such imbalance, if undesired, may be controlled by selection of a hash function that avoids the imbalance, and/or by changing the partition function periodically. Consider an undesirable event where a not insignificant volume of requests for content objects all happen to hash towards the same responsible peer. Although unlikely, such event might occur. Its probability of occurrence is largely dependent on the number of end users covered by the HRP federation and time of observation, and using of a hash function that avoids the imbalance and/or changing the allocation strategy (partition function) periodically may make an occurrence of such event highly unlikely. As an example, for a federation of four network peers, an appropriate allocation strategy may be to (i) divide the hash-value space into 16 equal segments, (ii) allocate to the four network peers respective key ranges—each consisting of one of four distinct groups of four segments, and (iii) rotate the key ranges periodically. As an example, segments 1-4 may be allocated to network peer A, segments 5-8 may be allocated to network peer B, etc. Every week at a fixed time, for example, the rotation takes place. After a first rotation, segments 2-5 may be allocated to peer A, segment 6-9 may be allocated to network peer B, etc. This may result in invalidating only a part of ¼^{th} of the cache capacity of each peer when a rotation occurs. A second way to treat the issue may be to introduce congestion flags in the HRP routing protocol. Congestion in one peer may result in various actions, for example shifting part of the key space of this peer to other peers.

In some embodiments a publisher may craft content object to ensure that a single network peer is always chosen for such content objects. If this occurs, a denial of service (DoS) attack may occur on such peer. Rotation and congestion mechanisms provided supra may be used to mitigate this risk.

In some embodiments, one of the network peers offers a sensibly lower level of service, while benefiting from the higher level of service of other network peers. As a result end users may get a different quality of experience for different content objects, depending on their descriptors. One resolution to this issue may be that the other peers reconfigure their HRP routers to (e.g., temporarily) exclude the undesired peer from the federation, e.g. re-distributing responsibility for key ranges originally allocated to the undesired peer, and stopping or reducing their own support to the undesired peer. This correction could also be automatic, based on RTT measurements made by HRP routers.

At times one or more of the HRP network peers may be out of service or otherwise unavailable, resulting in not being able to obtain content objects under the responsibility of such network peers. The HRP-enhanced routing protocol may enable determining an alternate route (i.e., in HRP context, an alternate key-range allocation) for the content requests. This alternate route may be determined using backup allocation entries for the key ranges associated with the unavailable HRP network peers. The backup allocation entries may be populated responsive to discovering the outages. Alternatively, backup allocations entries may be populated during primary key range allocation, and may be part of the allocation strategy. Additionally and/or alternatively, if no backup allocation entry is present for given key range, a peer can fallback to treat this key-range as “unallocated”, and therefore fetch it over its own transit link.

Summary-Routing Peering (SRP) for Content Network Federations

In an alternative implementation of content network federations, each network peer may advertise what it has in cache, e.g. in a bloom filter summary. This procedure may be referred to herein as Summary-Routing Peering (SRP). Before fetching a content object over transit/backhaul, a first network peer may check for presence of the content object in the local cache of one of the other network peers. If one or more target network peers are discovered during the check, then the first network peer may forward the request for content object to one of these target network peers. In some embodiments, the target network peer may provide the content object only if it is in its local cache. If the content object is not in its local cache, the target network peer reply with a negative response. Upon discovering that the content object is not available from any of the target network peers, the first network peer may request it from the Internet over its transit/backhaul.

In SRP, the network peers provide additional caching hit ratio through cooperative caching. For non-cached content objects or for non-cooperatively cached content objects, each network peer may rely on its own backhaul/transit link for fetching any such content object from the Internet. The network peers may exchange cache summaries. Exchange of the cache summaries for various reasons, such as, (i) due to cache replacement, objects present in the last advertisement may be removed already, and new objects not advertised may be cached instead; (2) due to summarization (bloom filter typically), there is a chance of false positive. The effects of (1) and (2) when combined may result in a false positive (messages are exchanged, but no match is found), resulting is additional delay to fetch an item, and (1) results in false negative (lost opportunity to benefit from caching because of race condition). If summarization messages are generated and exchanged often, and if the summary used is large enough, these effects can be reduced.

SRP may enable cooperative caching between networks/SCNs/Small Cells, over direct peering links, while leaving each network peer the responsibility to fetch any non-cached object requested by its end user. This may be an advantage in some situations, where the network peers do not wish to depend too much on each other. Despite requiring more involvements from network peers, HRP has additional benefits, including: (1) higher efficiency of any cache located deeper in the network (i.e. beyond the backhaul/transit link, (2) potential for traffic engineering to optimize caching and transit using new peering links as necessary, and (3) cooperative support of transit-less networks/SCNs/Small Cells. With respect to (2), in SRP routing, the cache summaries may be renewed often and flooded through the whole federation quickly, since the caching information may be becomes stale quickly and dynamic control flow may be well suited for small inter-networks. In HRP routing, the key-range allocation information may change less frequently than cache summary information, resulting in fewer control messages as compared to SRP, and may be well suited for larger and more complex inter-networks.

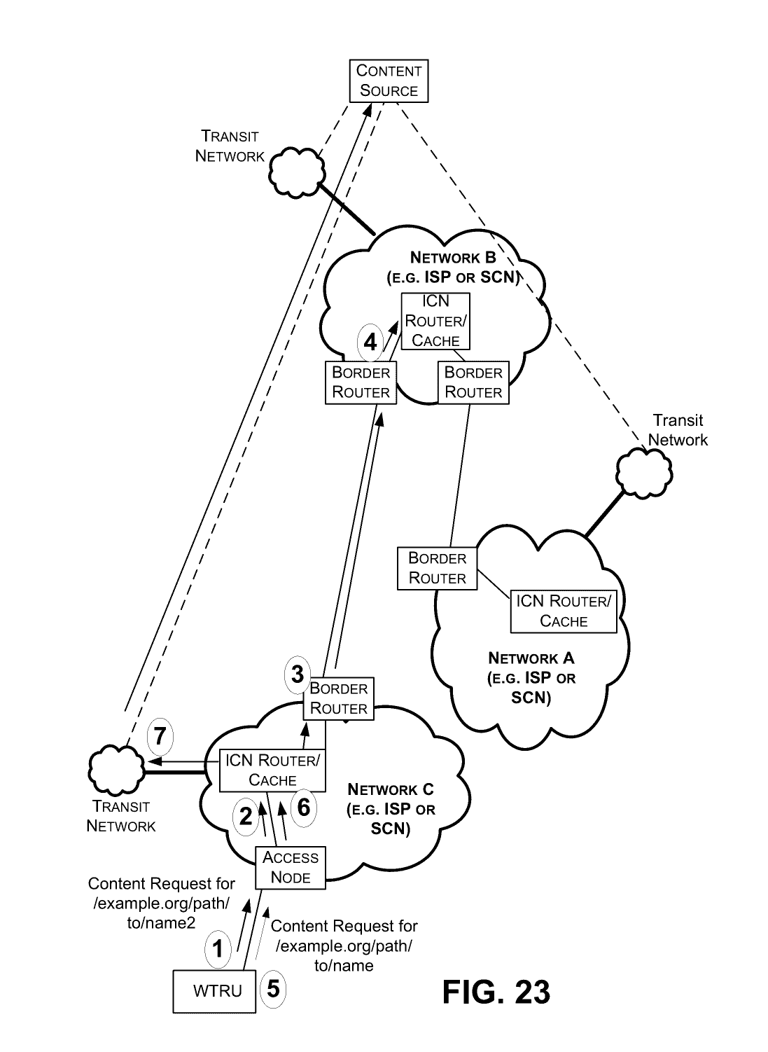

FIG. 23 is a block diagram illustrating an example of SRP routing. The SRP routing may be described with respect to a SRP routing table (TABLE 5)

Prior to 1, the border routers may (i) obtain cache summary from router/cache of their own domain, (ii) assemble this information into a cache summary, and (iii) provide this cache summary to all SRP network peers.

At 1, a WTRU may send a content request. At 2, the content request may reach a router/cache. The router/cache may discover that this content name matches a SRP routing entry's cache summary, and based on the discovery, may forward the request towards the border router given in this entry. The router/cache may have obtained the cache summaries from the border router, over an Interior SRP routing protocol, and the like. As shown in TABLE 5, entries in the SRP routing table may include cache summaries.

At 3, the SRP border router may check the content name for inclusion in all cache summaries present in its SRP routing table (TABLE 5). The SRP border router may discover match, and may forward the content request towards the SRP router present in the matching entry.

At 4: the receiving SRP router may forward the request towards its peer's cache. If several caches are present, the receiving SRP router may use their respective cache summaries to determine where to forward the request. Upon request, the cache may reply with the content object, which is sent back to the original requester.

At 5-6-7, the WTRU may send another request. This time, a content router in network peer C discovers that the content descriptor does not match any cache summaries, and based on this discovery, may forward the request towards the Internet through the transit link.

SRP Agreement

Several networks may enter into an SRP agreement by agreeing to share cached items and exchange SRP routing messages. The size of the cache storage space shared by each peer may be a factor in an SRP Agreement. Peers contributing a similar amount of cache might not need exchange payments. The cache storage space might not be an important factor, since it only translates into a lower cache hit ratio, and correspondingly less peering traffic. The size of the peering links may also influence the effectiveness of the scheme. Whether a peer accepts or not to route requests and data between 2 other peers may be a part of the SRP agreement.

SRP Routing Overview

Like HRP, SRP routing may arise from the need to enable exchange of cache summaries between peers connected over all kind of topologies such as hubs, full-mesh, loose-mesh or a mix of those. The cache summary advertised by each network/SCN/cell peer may be flooded in the network using an extension of an existing protocol such as BGP, OSPF, intermediate system to intermediate system (IS-IS) or others. Each peer may build a routing table including entries with the following information elements:

(i) cache summary (typically, a bloom filter summarizing the cache content);

(ii) destination SRP router or cache, which may be a label or a locator;

(iii) next hop SRP router locator or label; and

(iv) cost, which may reflect the distance, monetary cost, link usage, or a combination thereof.

TABLE 5

| | | | | HRP Cost (e.g. |
|---|---|---|---|---|
| | | Target Network | | number of hops, |
| | | Label (maybe a | Next Hop | monetary cost, |
| Table | Summary | string, an IP | (Locator | policy based |
| Entry | Bloom | address, an IP | of next | cost, or a mix of |
| Index | Filter | subnet, etc.) | hop router) | those) |
| 1 | 0x12341234 | A | 5.6.7.8 | 2 |
| 2 | 0x00346702 | B | 5.6.7.8 | 1 |
| 3 | 0x12125600 | C | 1.2.3.4 | 0 |
| 4 | 0x00012345 | C | 1.2.3.5 | 0 |

Table 5 is an example of SRP routing table in SRP border router of network peer C. The next hop for network peers A and B may be the same. The next hop 5.6.7.8 may be, for example, a HRP router of network peer B. According to the SRP routing table, HRP router of network peer A may be reached through network peer B. Network peer C may have two local caches at IP address 1.2.3.4 and 1.2.3.5. The SRP router of network peer C may collect cache summaries from both of them and may send two advertisements to its peers, or a single advertisement with a coalesced cache summary.

The cache summary information may be updated as often as possible. Among the routing information included in the SRP routing table it is may be the most dynamic information element, and it does not influence the route itself but only the decision making process of the network peers. While the rest of the route may be set up using extension of existing routing protocols, such as new information elements in existing messages or new semantic to existing information elements, such protocols may be further extended with an additional cache summary flooding mechanism. This cache summary flooding mechanism may be configured to efficiently flood information elements related to an existing route.

Consider a routing protocol like OSPF, and assume that in the context of IP networking, each SRP router may advertises reachability to an internal LAN using unmodified OSPF protocol. In steady state, every SRP router may have a routing table with each entry including, for example:

(i) cache or SRP router locator (e.g. 1.2.3.0/24 for IPv4 in CIDR notation);
(a) there may be a single entry per SRP router, in which case all requests may go to the SRP router (which can be co-located with the cache itself, or which can then forward to a cache internally); and/or
(b) there could be several entries, one per cache present inside the peer network. (the SRP router may simply forward a request towards a cache, effectively acting as an IP router);

(ii) next hop (e.g. 4.5.6.7 IPv4 address of next hop SRP router); and

(iii) cost (e.g. an integer)

Each SRP router may collect/receive cache summaries from caches located in its own LAN, e.g. using HTTP messages, or using a management protocol like NetConf or SNMP. The SRP may send a SRP Route Information Update message to all its neighbors, which, in turn, may forward it to all neighbors, etc. Loops can be easily avoided by not forwarding to a network peer that already sent us the update, and by dropping/ignoring any update that comes from a network peer towards which the update was already sent. The Route Information Update message may include one or more of the following:

(i) an identifier of the route this update relates to (e.g. Cache or SRP router locator);

(ii) a unique ID for this update (e.g. an integer incremented for each update); and

(iii) information elements to attach to the route, such as, for example: an up-to-date cache summary.

Upon receipt, an SRP router may take the following actions:

(i) if applicable, drop to avoid looping (e.g. drop if already received), else forward towards all peers that that get this same update from;

(ii) if a route with the same identifier is obtained, attach the information element to the route (first update), and/or replace the current information element attached to the route with the updated one (subsequent updates).

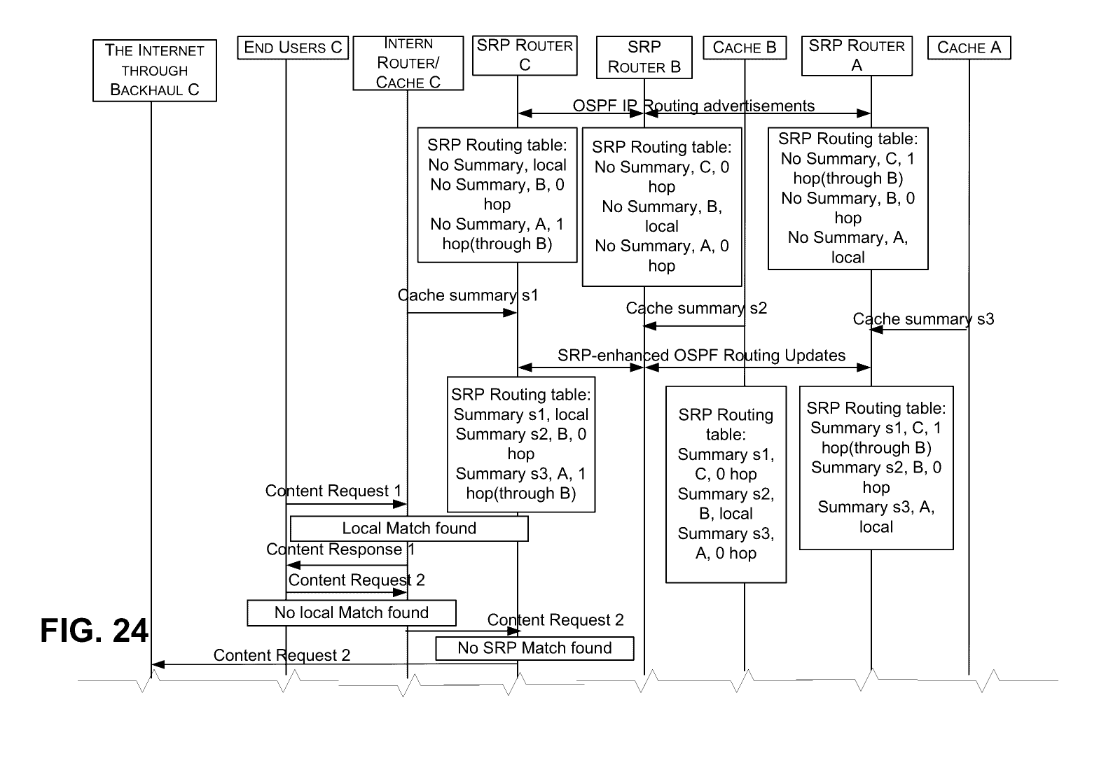

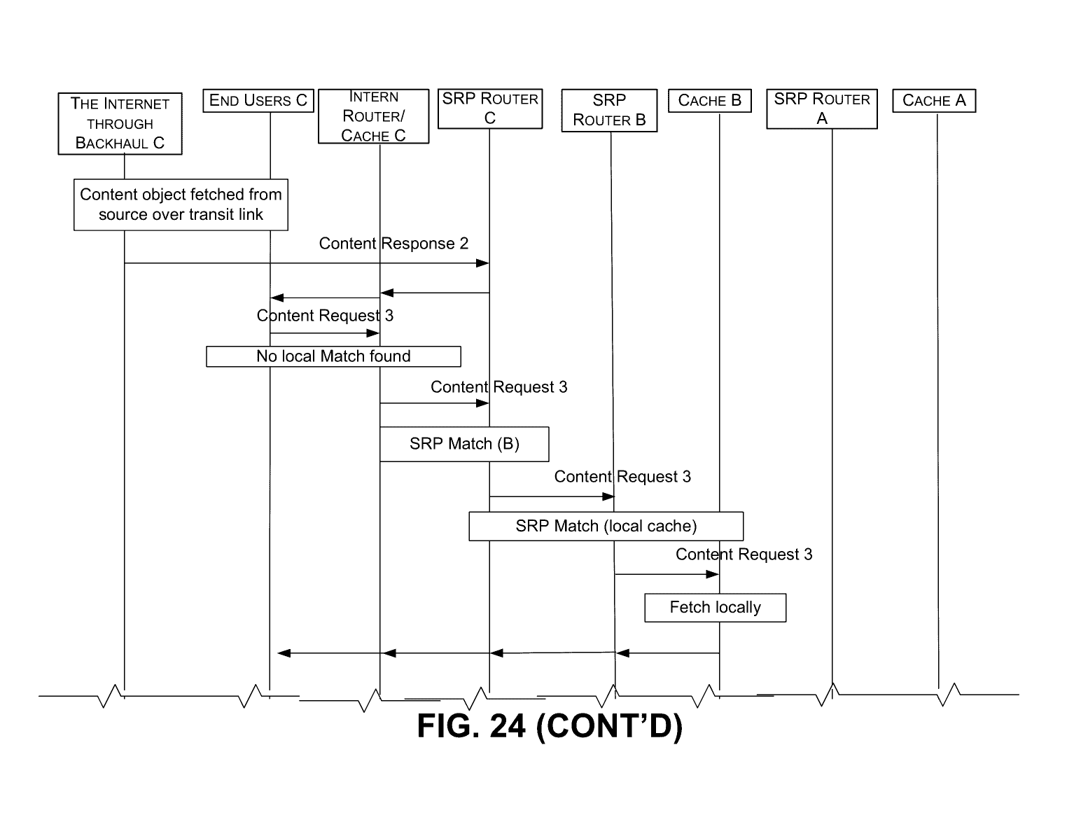

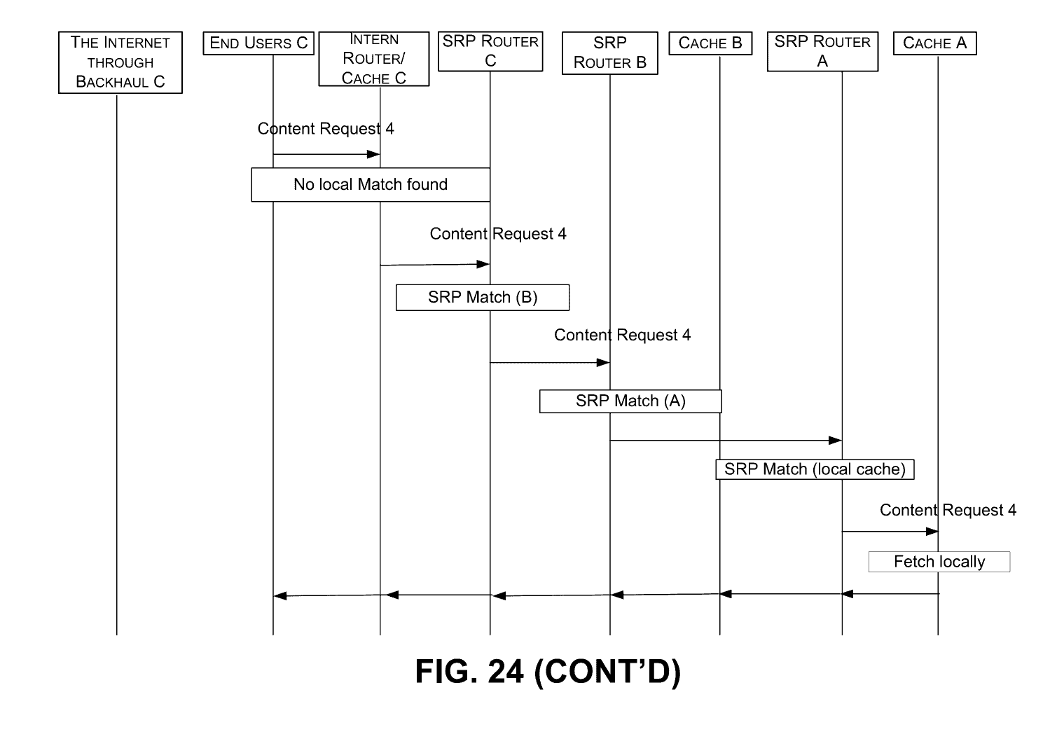

FIG. 24 is a message flow diagram illustrating an example SRP message flow 2400. The SRP message flow 2400 shows messages exchanged for the example of SRP routing procedure of FIG. 23.

In a first phase of the message flow 2400, the SRP routers may exchange IP Routing, and then SRP routing updates. SRP router B is on the path between A and C. At the end of this process, each SRP router may have an up-to-date SRP routing table. At later time (not shown), the process of collecting cache summaries from caches and flooding the information in the SRP inter-network using SRP routing updates may continue, on a periodic basis.

The four different content requests may be initiated by the WTRU. The first content request may be replied to by a local cache. The second content request may not be found to be in any local or SRP peer cache, and is forwarded to the Internet over the backhaul link. The third content request may end up being served by a cache in domain B. The fourth request may be found to match a cache summary advertised by network peer B to network peers C. When the request reaches network peer B, the SRP router may determine that the content object matches a summary sent by network peer A. The content request may be forwarded to network peer A, where it is served by from a cache of network peers A.

Example of Routing Protocol Extensions

Routing extensions for SRP may be similar to HRP extensions—replacing the key range with a cache summary. SRP routes may be exchanged between SRP peers, and if multiple border routers exist in a network peer, it may distribute the SRP routing table inside the network. SRP extensions may be derived from the examples provided supra. For example, BGP NLRI may be extended with SRP reachability information.

FIG. 25 illustrates a BGP Extension for SRP Reachability Information (new NLRI type). The cache summary information format may include cache summary type information, along with a size and a bloom filter (the summary type information is an enumerated type designating the encoding details, e.g. bloom filter, number and definition of hash functions, etc.).

### Embodiments

In representative embodiment 1, a method, implemented in a network peer of a federation of network peers, may include selecting a key range within a hash-value space of a hash function based on caching and/or backhaul resources of the network peer, advertising to the other network peers that the network peer has allocated to itself the key range, and configuring the network peer to utilize its caching and/or backhaul resources for fulfilling requests for any content object corresponding to a key within the key range.

In representative embodiment 2, the method of representative embodiment 1, wherein the network peer is configured on condition that the key range is not allocated to the other network peers.

In representative embodiment 3, the method of any of the representative embodiments 1-2 may further include, prior to selecting the key range, listening for one or more advertisements advertising currently allocated key ranges, and determining unallocated hash-value space based on the hash-value space and advertised currently allocated key ranges, wherein selecting the key range may include selecting the key range from unallocated hash-value space based on caching and/or backhaul resources of the network peer

In representative embodiment 4, the method of any of the representative embodiments 1-3 may further include receiving from another network peer an advertisement advertising that the other network has allocated to itself another key range, and configuring the network peer with information for routing and/or forwarding, to the other network peer, requests for any content object corresponding to a key within the other key range.

In representative embodiment 5, the method of any of the representative embodiments 1-4 may further include receiving a message that indicates that at least one key of the key range is currently allocated to another network peer, and negotiating with the other network peer to re-allocate to the network peer the at least one key of the key range currently allocated to the other network peer.

In representative embodiment 6, the method of any of the representative embodiments 1-5 may further include receiving a message that indicates at least one key of the key range is currently allocated to another network peer, and sending to the other network peer an advertisement advertising that the network peer has revised the key range to exclude the at least one key of the key range currently allocated to the other network peer, wherein configuring the network may include configuring the network peer to utilize its caching and/or backhaul resources for fulfilling requests for any content object corresponding to a key of the revised key range.

In representative embodiment 7, the method of any of the representative embodiments 1-5 may further include receiving from another network peer an advertisement advertising that the other network has allocated to itself the key range, negotiating with the other network peer to re-allocate the key range to the other network peer, and reconfiguring the network peer with information for routing and/or forwarding, to the other network peer, requests for any content object that corresponds to the key range.

In representative embodiment 8, the method of the representative embodiment 7 may further include advertising to the other network peers that the network peer has allocated to itself a new key range, and configuring the network peer to utilize its caching and/or backhaul resources for fulfilling requests for any content object corresponding to a key of the new key range.

In representative embodiment 9, the method of the representative embodiment 7 may further include negotiating with the other network peers an allocation of a different key range, and configuring the network peer to utilize its caching and/or backhaul resources for fulfilling requests for any content object corresponding to a key of the different key range.

In representative embodiment 10, the method of the representative embodiment 1 may further include receiving from another network peer an advertisement advertising that the other network has allocated to itself another key range that includes at least one key of the key range, sending to the other network peer a message that indicates that the at least one key of the key range is currently allocated to the first network, negotiating with the other network peer to allocate to the other network peer a revised key range that excludes the key range currently allocated to the first network, and configuring the network peer with information for routing and/or forwarding, to the other networks, requests for any content object that corresponds to the revised key range.

In representative embodiment 11, the method of the representative embodiment 1 may further include receiving from another network peer an advertisement advertising that the other network has allocated to itself the key range, negotiating with the other networks to (i) re-allocate to the other network peer a first portion of the key range, and (ii) allocate to the network peer a second portion of the key range, and reconfiguring the network peer (i) to fulfill requests for any content object that corresponds to the first portion of the key range, and (ii) with information for routing and/or forwarding, to the other network peer, requests for any content object that corresponds to the second portion of the key range.

In representative embodiment 12, the method of any of the representative embodiments 1-11, wherein selection of the key range is further based on one or more characteristics of, and/or traffic conditions associated with, a communication link between two of the network peers.

In representative embodiment 13, the method of the representative embodiment 1 may further include revising the key range based on one or more characteristics of, and/or traffic conditions associated with, a communication link between two of the network peers,

advertising to the other network peers that the network peer will utilize its caching and/or backhaul resources to fulfill requests for any content object that corresponds to the revised key range, and re-configuring the network peer to fulfill requests for any content object that corresponds to the revised key range.

In representative embodiment 14, the method of the representative embodiment 1, wherein configuring the network peer may include storing the key range in connection with an identity of the network peer in a data structure maintained in memory of the entity.

In representative embodiment 15, the method of the representative embodiment 4, wherein configuring the network peer may include storing the other key range in connection with an identity of the other network in the data structure maintained in memory of the entity.

In representative embodiment 16, the method of the representative embodiments 12, wherein configuring the network peer may include storing the key range in connection with an identity of the network peer in the data structure.

In representative embodiment 17, the method of any of the representative embodiments 15-16, wherein the data structure is a routing table.

In representative embodiment 18, the method of any of the preceding representative embodiments, wherein allocation of key ranges is based on an allocation strategy.

In representative embodiment 19, the method of the representative embodiment 18, wherein the allocation strategy includes a partition function.

In representative embodiment 20, an apparatus, which may include any of receiver, transmitter and processor, configured to perform a method as in at least one of the preceding embodiments.

In representative embodiment 21, a system configured to perform a method as in at least one of the embodiment 1-19.

In representative embodiment 22, a plurality of network peers configured to perform a method as in at least one of the embodiments 1-19.

In representative embodiment 23, a network peer configured to perform a method as in at least one of the embodiments 1-19.

In representative embodiment 24, a tangible computer readable storage medium having stored thereon computer executable instructions for performing a method as in at least one of the embodiments 1-19.

In representative embodiment 25, a method, implemented in a network peer of a federation of network peers, may include receiving from another network peer an advertisement advertising that the other network has allocated to itself a key range within a hash value space of a hashing function, and configuring the network peer with information for routing and/or forwarding, to the other network peer, requests for any content object corresponding to a key within the other key range.

In representative embodiment 26, the method of the representative embodiment 25, wherein configuring the network peer with information may include maintaining a mapping between the key range and an identity of the other network peer.

In representative embodiment 27, the method of any of the representative embodiments 25-26, wherein maintaining a mapping between the key range and an identity of the other network peer may include populating a data structure with the identity in connection with the key range.

In representative embodiment 28, the method of the representative embodiment 27, wherein the data structure is a routing table.

In representative embodiment 29, the method of the representative embodiment 27, wherein the data structure is a forwarding information base.

In representative embodiment 30, the method of any of the representative embodiment 25-28 may further include selecting another key range within a hash-value space based on caching and/or backhaul resources of the network peer, advertising to the other network peers that the network peer has allocated to itself the other key range, and configuring the network peer to utilize its caching and/or backhaul resources for fulfilling requests for any content object corresponding to a key within the other key range.

In representative embodiment 31, an apparatus, which may include any of receiver, transmitter and processor, configured to perform a method as in at least one of the embodiments 25-30.

In representative embodiment 32, a system configured to perform a method as in at least one of the embodiment 25-30.

In representative embodiment 33, a plurality of network peers configured to perform a method as in at least one of the embodiments 25-30.

In representative embodiment 34, a network peer configured to perform a method as in at least one of the embodiments 25-30.

In representative embodiment 35, a tangible computer readable storage medium having stored thereon computer executable instructions for performing a method as in at least one of the embodiments 25-30.

In representative embodiment 36, a method may include receiving a content request having a content identifier associated with a desired content object, obtaining a hash value from hashing the content identifier; and determining a network-peer ID of a network peer responsible for serving the content object based on the obtained hash value and a mapping between a plurality of network-peer IDs and a plurality of shares allocated to a respective plurality of network peers.

In representative embodiment 37, the method of the representative embodiment 36 may further include routing and/or forwarding the content request to the responsible network peer based on the determined network-peer ID.

In representative embodiment 38, the method of the representative embodiment 37 may further include receiving the content object from the responsible network peer; and serving the content object from the network peer receiving the content request.

In representative embodiment 39, the method of any of the representative embodiment 36-38 may further include determining that the content object is stored in a local cache associated with the network peer receiving the content request; retrieving the content object from the local cache; and serving the content object from the network peer receiving the content request.

In representative embodiment 40, the method of any of the representative embodiment 36-38 may further include determining that the network peer receiving the content request is the responsible network peer based on the network-ID; determining that the content object is not available from a local cache associated with the responsible network peer; retrieving the content object from a content source via a transit (backhaul) network or link; and serving the content object from the network peer receiving the content request.

In representative embodiment 41, the method of any of the representative embodiment 36-40 may further include receiving, at the responsible network peer, the content request forwarded from another network peer; determining that the content object is available from a local cache associated with the responsible network peer; retrieving the content object from the local cache; and sending the content object towards the network peer that received the content request.

In representative embodiment 42, the method of any of the representative embodiment 36-40 may further include receiving, at the responsible network peer, the content request forwarded from another network peer; determining that the content object is not available from a local cache associated with the responsible network peer; retrieving the content object from a content source via a transit (backhaul) network or link; and sending the content object towards the network peer that received the content request.

In representative embodiment 43, an apparatus, which may include any of receiver, transmitter and processor, configured to perform a method as in at least one of the embodiments 36-42.

In representative embodiment 44, a system configured to perform a method as in at least one of the embodiments 36-42.

In representative embodiment 45, a plurality of network peers configured to perform a method as in at least one of the embodiments 36-42.

In representative embodiment 46, a network peer configured to perform a method as in at least one of the embodiments 36-42.

In representative embodiment 46, a tangible computer readable storage medium having stored thereon computer executable instructions for performing a method as in at least one of the embodiments 36-42.

In representative embodiment 47, a method may include

federating multiple independent networks so as to form a network federation in which the multiple independent networks cooperate to pool and/or merge resources to make available to such cooperating networks some amount of content objects, and in which each of the cooperating networks undertakes responsibility for making available to at least some of the other cooperating networks a share of the amount of content objects that the cooperating networks agree to support.

In representative embodiment 48, an apparatus, which may include any of receiver, transmitter and processor, configured to perform a method as in embodiment 47.

In representative embodiment 49, a system configured to perform a method as in embodiment 47.

In representative embodiment 50, a plurality of network peers configured to perform a method as in embodiment 47.

In representative embodiment 51, a network peer configured to perform a method as in embodiment 47.

In representative embodiment 52, a tangible computer readable storage medium having stored thereon computer executable instructions for performing a method as in the embodiment 47.

In representative embodiment 53, a method, implemented in an entity of a first of a plurality of network peers, may include receiving a message for requesting a content object, wherein the content object corresponds to a key within a key range of a hash value space of a hash function; and determining a next hop destination for the message based on an indication of which network peer of the plurality of network peers will utilize its caching and/or backhaul resources to fulfill a request for any content object that corresponds to a key within the key range.

In representative embodiment 54, an apparatus, which may include any of receiver, transmitter and processor, configured to perform a method as in embodiment 53.

In representative embodiment 55, a system configured to perform a method as in embodiment 53.

In representative embodiment 56, a plurality of network peers configured to perform a method as in embodiment 53.

In representative embodiment 57, a network peer configured to perform a method as in embodiment 53.

In representative embodiment 58, a tangible computer readable storage medium having stored thereon computer executable instructions for performing a method as in the embodiment 53.

### CONCLUSION

Note that this work focuses on optimizing caching of content. Non-cacheable content, such as real time end-to-end communications and other interactive communications are not in the scope of this work. Such traffic will coexist with HRP, i.e. an ISP can continue routing such traffic as it is done today, and use HRP routing for content request and response such as HTTP GET or ICN content requests.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, the term “video” may mean any of a snapshot, single image and/or multiple images displayed over a time basis. As another example, when referred to herein, the terms “user equipment” and its abbreviation “UE” may mean (i) a wireless transmit and/or receive unit (WTRU), such as described supra; (ii) any of a number of embodiments of a WTRU, such as described supra; (iii) a wireless-capable and/or wired-capable (e.g., tetherable) device configured with, inter alia, some or all structures and functionality of a WTRU, such as described supra; (iii) a wireless-capable and/or wired-capable device configured with less than all structures and functionality of a WTRU, such as described supra; or (iv) the like. Details of an example WTRU, which may be representative of any UE recited herein, are provided below with respect to FIGS. 1A-1E.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (CPU″) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM″)) or non-volatile (e.g., Read-Only Memory (ROM″)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

1-17. (canceled)

18. A method, implemented in an entity of a first network peer of a federation of network peers, the method comprising:
receiving a message for requesting a content object, wherein the content object corresponds to a key within a key range of a hash value space of a hash function, wherein the key range is allocated to one of the network peers of the federation of network peers;
determining, from the key, an indication of which one of the network peers of the federation of network peers will utilize its allocated resources to fulfill a request for any content object that corresponds to the key; and
determining a next hop destination for the message based on the indication.

19. The method of claim 18, wherein determining a next hop destination comprises determining, based on the indication, the content object is retrievable from a local cache in the first network peer, the method further comprising:
fetching the content object from the local cache; and
sending a response to the message for requesting a content object, wherein the response includes the fetched content object.

20. The method of claim 18, wherein determining a next hop destination comprises determining, based on the indication, the content object is retrievable from a second network peer of the federation of network peers, the method further comprising:
forwarding the message for requesting a content object to the second network peer.

21. The method of claim 18, wherein determining an indication comprises obtaining the key corresponding to the content object, and wherein the key is obtained by any of (i) calculating a hash value using at least one of a content name and metadata associated with the content object, and (ii) retrieving the hash value from the received message.

22. The method of claim 18, wherein determining a next hop destination comprises determining the next hop destination based on the indication and cost information, wherein the cost information includes at least one of: a number of hops, monetary cost, and policy based cost.

23. The method of claim 18, wherein the allocated resources comprise any of transit resources, backhaul resources and caching resources.

24. The method of claim 18, further comprising:
negotiating routing capability with a second network peer of the federation of network peers;
advertising first reachability information associated with the first network peer to the second network peer of the federation of network peers;
receiving, from the second network peer, second reachability information associated with the second network peer;
receiving, from the second-network entity, updated second reachability information associated with the second network peer, wherein the updated second reachability information includes changes to de-allocating a previously allocated key range or allocating a new key range; and
updating a routing entry based on the received updated second reachability information associated with the second network peer to reflect the changes,
wherein the routing capability includes key range allocation granularity and network-peer identity advertisement, and
wherein the first and the second reachability information include key-range-reachability information and Internet Protocol (IP) reachability information, wherein the first reachability information is populated by the second network peer in a routing table associated with the second network peer, and wherein the second reachability information is populated into a routing table associated with the first network peer.

25. A network entity of a first network peer of a federation of network peers, the network entity comprising a processor configured to:
receive a message for requesting a content object, wherein the content object corresponds to a key within a key range of a hash value space of a hash function, wherein the key range is allocated to one of the network peers of the federation of network peers;
determine, from the key, an indication of which one of the network peers of the federation of network peers will utilize its allocated resources to fulfill a request for any content object that corresponds to the key; and
determine a next hop destination for the message based on the indication.

26. The network entity of claim 25, wherein the processor is configured to:
determine, based on the indication, the content object is retrievable from a local cache in the first network peer;
fetch the content object from the local cache; and
send a response to the message for requesting a content object, wherein the response includes the fetched content object.

27. The network entity of claim 25, wherein the processor is configured to:
determine, based on the indication, the content object is retrievable from a second network peer of the federation of network peers; and
forward the message for requesting a content object to the second network peer.

28. The network entity of claim 25, wherein the processor is configured to obtain the key corresponding to the content object by any of (i) calculating a hash value using any of a content name and metadata associated with the content object, and (ii) retrieving the hash value from the received message.

29. The network entity of claim 25, wherein the processor is configured to determine a next hop destination based on the indication and cost information, wherein the cost information includes at least one of: a number of hops, monetary cost, and policy based cost.

30. The network entity of claim 25, wherein the allocated resources comprise any of transit resources, backhaul resources and caching resources.

31. The network entity of claim 25, wherein the processor is configured to:
negotiate routing capability with a second network peer of the federation of network peers;
advertise first reachability information associated with the first network peer to the second network peer of the federation of network peers;
receive, from the second network peer, second reachability information associated with the second network peer;
receive, from the second-network entity, updated second reachability information associated with the second network peer, wherein the updated second reachability information includes changes to de-allocating a previously allocated key range or allocating a new key range; and
update a routing entry based on the received updated second reachability information associated with the second network peer to reflect the changes,
wherein the routing capability includes key range allocation granularity and network-peer identity advertisement, and
wherein the first and the second reachability information include key-range-reachability information and Internet Protocol (IP) reachability information, wherein the first reachability information is populated by the second network peer in a routing table associated with the second network peer, and wherein the second reachability information is populated into a routing table associated with the first network peer.

32. A method implemented in a first network peer of a federation of network peers, the method comprising:
selecting a key range of a hash-value space of a hash function based on an amount of resources of the first network peer allocated to the federation;
advertising to the other network peers that the first network peer has allocated to itself the key range; and
configuring the first network peer to utilize the allocated resources for fulfilling a request for any content object corresponding to a key within the key range.

33. The method of claim 32, wherein the resources of the first network peer allocated to the federation comprise any of transit resources, backhaul resources and caching resources.

34. The method of claim 32, wherein configuring the first network peer is conditioned on the key range not being allocated to the other network peers.

35. The method of claim 32, further comprising:
prior to selecting the key range,
listening for one or more advertisements advertising currently allocated key ranges, and
determining unallocated hash-value space based on the hash-value space and advertised currently allocated key ranges,
wherein selecting the key range comprises selecting the key range from unallocated hash-value space.

36. The method of claim 32, further comprising:
receiving, from a second network peer of the federation of network peers, an advertisement advertising that the second network peer has allocated to itself another key range; and
configuring the first network peer with information for any of routing and forwarding, to the second network peer, a request for any content object corresponding to a key within the other key range.

37. The method of claim 32, further comprising:
revising the key range based on one or more characteristics of a communication link between the first network peer and a second network peer of the federation of network peers;
advertising to the other network peers of the federation of network peers that the first network peer will utilize the allocated resources to fulfill a request for any content object that corresponds to the revised key range; and
re-configuring the first network peer to fulfill a request for any content object that corresponds to the revised key range.
